(19) United States
(12) Patent Application Publication
(10) Pub. No.: US 2025/0055644 A1
(43) Pub. Date: Feb. 13, 2025

(54) WIRELESS COMMUNICATION METHOD AND COMMUNICATION DEVICE

(71) Applicant: GUANGDONG OPPO MOBILE TELECOMMUNICATIONS CORP., LTD., Dongguan (CN)

(72) Inventors: Jianfei CAO, Dongguan (CN); Zhe LIU, Dongguan (CN)

(21) Appl. No.: 18/931,609

(22) Filed: Oct. 30, 2024

Related U.S. Application Data
(63) Continuation of application No. PCT/CN2022/106294, filed on Jul. 18, 2022.

(51) Int. Cl. H04L 5/00; H04W 72/232

(52) U.S. Cl. CPC H04L 5/0053; H04L 5/0035; H04W 72/232

(57) ABSTRACT

A wireless communication method and a communication device are provided. The method includes: a terminal device receives a first unified transmission configuration indication (TCI) state and/or a second unified TCI state sent by a network device, the first unified TCI state being used for a first uplink channel/signal and/or a first downlink channel/signal, the second unified TCI state being used for a second uplink channel/signal and/or a second downlink channel/signal, the first uplink channel/signal and the second uplink channel/signal having different receiving ends and the same transmitting end, and the first downlink channel/signal and the second downlink channel/signal having different transmitting ends and the same receiving end.

### CROSS-REFERENCE TO RELATED APPLICATION

This application is a continuation of International Patent Application No. PCT/CN2022/106294 filed on Jul. 18, 2022, the disclosure of which is hereby incorporated by reference in its entirety.

### BACKGROUND

A concept of Unified Transmission Configuration Indication (TCI) state was proposed in the 3rd Generation Partnership Project (3GPP) protocol, which is used for beam indication of downlink Quasi Co-Location (QCL) and transfer of QCL information in the time domain and frequency domain. QCL is used to describe a relationship of large-scale fading from a source reference signal to a target reference signal. For the beam indication, User Equipment (UE) may receive the target reference signal by a receiving beam that receives the source reference signal after obtaining the QCL relationship between the source reference signal and the target reference signal from a network device (NW). However, the indication mechanism of the TCI state is only applicable to downlink channels and signals. In order to provide a unified uplink and downlink beam management mechanism, the concept of unified TCI state is proposed. However, the unified TCI state integrates the uplink channel and downlink channel onto the same beam, which is only for a Single Transmission Reception Point (sTRP) and does not apply to a scenario of Multiple Transmission Reception Point (mTRP).

### SUMMARY

Embodiments of the disclosure relate to the technical field of the mobile communications, and provide a wireless communication method and a communication device.

A wireless communication method provided by an embodiment of the disclosure includes the following operation. A terminal device receives a first unified TCI state and/or a second unified TCI state sent from a network device. The first unified TCI state is used for a first uplink channel/signal and/or a first downlink channel/signal, and the second unified TCI state is used for a second uplink channel/signal and/or a second downlink channel/signal. The first uplink channel/signal and the second uplink channel/signal have different receiving ends and the same transmitting end, and the first downlink channel/signal and the second downlink channel/signal have different transmitting ends and the same receiving end.

A wireless communication method provided by an embodiment of the disclosure includes the following operation. A network device sends a first unified TCI state and/or a second unified TCI state to a terminal device. The first unified TCI state is used for a first uplink channel/signal and/or a first downlink channel/signal, and the second unified TCI state is used for a second uplink channel/signal and/or a second downlink channel/signal. The first uplink channel/signal and the second uplink channel/signal have different receiving ends and the same transmitting end, and the first downlink channel/signal and the second downlink channel/signal have different transmitting ends and the same receiving end.

The communication device includes a processor, a memory and a transceiver. The memory is configured to store a computer program, and the processor is configured to call and run the computer program stored in the memory to control the transceiver to perform an operation of receiving, by a terminal device, a first unified Transmission Configuration Indication (TCI) state and/or a second unified TCI state sent from a network device, wherein the first unified TCI state is used for a first uplink channel/signal and/or a first downlink channel/signal, the second unified TCI state is used for a second uplink channel/signal and/or a second downlink channel/signal, the first uplink channel/signal and the second uplink channel/signal have different receiving ends and a same transmitting end, and the first downlink channel/signal and the second downlink channel/signal have different transmitting ends and a same receiving end.

### BRIEF DESCRIPTION OF THE DRAWINGS

The drawings illustrated herein are used to provide a further understanding of the disclosure and form a part hereof. Schematic embodiments of the disclosure and their illustrations are used to explain the disclosure and do not constitute an undue limitation of the disclosure.

FIG. 1 is a schematic diagram of an application scenario of an embodiment of the disclosure.

FIG. 2 is a schematic diagram of an optional scenario of PDCCH repetition transmission of an embodiment of the disclosure.

FIG. 3 is a schematic diagram of an optional scenario of PDCCH SFN transmission of an embodiment of the disclosure.

FIG. 4 is a schematic diagram of an optional scenario of PUCCH transmission of an embodiment of the disclosure.

FIG. 5 is a schematic diagram of an optional scenario of PUSCH transmission of an embodiment of the disclosure.

FIG. 6 is an optional schematic flowchart of a wireless communication method of an embodiment of the disclosure.

FIG. 7 is an optional schematic flowchart of a wireless communication method of an embodiment of the disclosure.

FIG. 8 is an optional schematic flowchart of a wireless communication method of an embodiment of the disclosure.

FIG. 9 is an optional schematic flowchart of a wireless communication method of an embodiment of the disclosure.

FIG. 10 is a schematic diagram of an optional structure of a wireless communication apparatus of an embodiment of the disclosure.

FIG. 11 is a schematic diagram of an optional structure of a wireless communication apparatus of an embodiment of the disclosure.

FIG. 12 is a schematic diagram of a structure of a communication device provided by an embodiment of the disclosure.

FIG. 13 is a schematic diagram of a structure of a chip of an embodiment of the disclosure.

FIG. 14 is a schematic block diagram of a communication system provided by an embodiment of the disclosure.

### DETAILED DESCRIPTION

The technical solutions in the embodiments of the disclosure will be described below in combination with the drawings in the embodiments of the disclosure. It is apparent that the described embodiments are a part of the embodiments of the disclosure and not all of the embodiments. Based on the embodiments of the disclosure, all other embodiments obtained by those of ordinary skill in the art without making creative labor fall within the scope of protection of the disclosure.

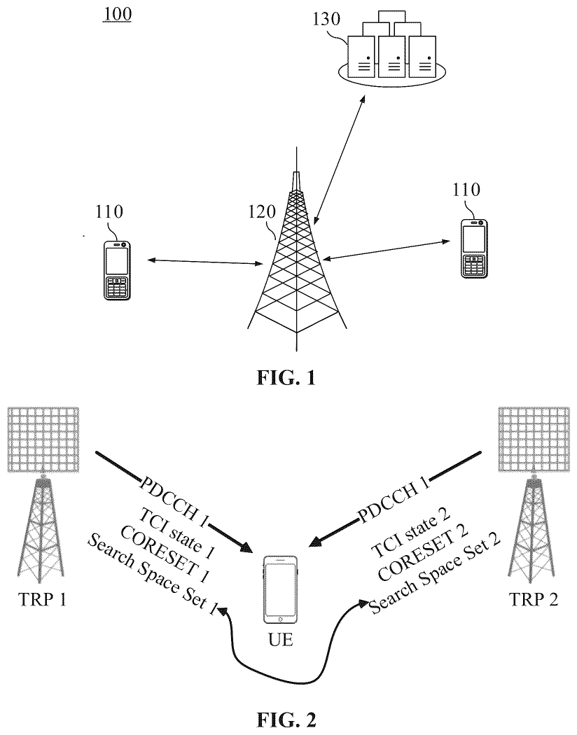

FIG. 1 is a schematic diagram of an application scenario of an embodiment of the disclosure.

As shown in FIG. 1, a communication system 100 may include a terminal device 110 and a network device 120. The network device 120 may communicate with the terminal device 110 through an air interface. Multi-service transmission is supported between the terminal device 110 and the network device 120.

It is to be understood that the embodiments of the disclosure are only illustrated exemplarily with the communication system 100, but are not limited thereto. That is, the technical solutions of the embodiments of the disclosure may be applied to various communication systems, for example, a Long Term Evolution (LTE) system, an LTE Time Division Duplex (TDD), a Universal Mobile Telecommunication System (UMTS), an Internet of Things (IoT) system, a Narrow Band Internet of Things (NB-IoT) system, an enhanced Machine-Type Communications (eMTC) system, a 5th generation (5G) communication system (which is also referred to as a New Radio (NR) communication system), a future communication system, or the like.

In the communication system 100 shown in FIG. 1, the network device 120 may be an access network device that communicates with the terminal device 110. The access network device may provide communication coverage for a specific geographic region and may communicate with a terminal device 110 (for example, User Equipment (UE)) located within the coverage region.

The network device 120 may be an Evolutional Node B (eNB or eNodeB) in an LTE system, a Next Generation Radio Access Network (NG RAN) device, a base station (gNB) in an NR system, or a radio controller in a Cloud Radio Access Network (CRAN). Alternatively, the network device 120 may be a relay station, an access point, an on-board device, a wearable device, a hub, a switch, a network bridge, a router, a network device in the future evolved Public Land Mobile Network (PLMN), or the like.

The terminal device 110 may be any terminal device, which includes, but is not limited to, a terminal device that has a wired or wireless connection to the network device 120 or other terminal devices.

For example, the terminal device 110 may refer to an access terminal, UE, a user unit, a user station, a mobile station, a mobile platform, a remote station, a remote terminal, a mobile device, a user terminal, a terminal, a wireless communication device, a user agent, or a user apparatus. The access terminal may be a cellular telephone, a cordless telephone, a Session Initiation Protocol (SIP) telephone, an IoT device, a satellite handheld terminal, a Wireless Local Loop (WLL) station, a Personal Digital Assistant (PDA), a handheld device with a wireless communication function, a computing device or other processing devices connected to a wireless modem, an on-board device, a wearable device, a terminal device in a 5G network, a terminal device in a future evolution network, or the like.

The terminal device 110 may be used for Device to Device (D2D) communication.

The wireless communication system 100 may further include a core network device 130 that communicates with a base station. The core network device 130 may be a 5G Core (5GC) device, such as an Access and Mobility Management Function (AMF), an Authentication Server Function (AUSF), a User Plane Function (UPF), or a Session Management Function (SMF). Optionally, the core network device 130 may also be an Evolved Packet Core (EPC) device of the LTE network, for example, a Session Management Function+Core Packet Gateway (SMF+PGW-C) device. It is to be understood that the SMF+PGW-C is able to achieve functions that can be achieved by the SMF and the PGW-C at the same time. In the process of network evolution, the aforementioned core network device may also be called by other names, or new network entities may be formed by dividing the functions of the core network, which is not limited by the embodiments of the disclosure.

Communication may further be achieved between various function units in the communication system 100 by establishing a connection through a next generation (NG) interface.

For example, the terminal device establishes an air interface connection with the access network device through a Uu interface for transmitting user plane data and control plane signallings. The terminal device may establish a control plane signalling connection with the AMF through NG interface 1 (abbreviated as N1). The access network device, such as a next-generation wireless access base station (gNB), may establish a user plane data connection with the UPF through NG interface 3 (abbreviated as N3). The access network device may establish a control plane signalling connection with the AMF through NG interface 2 (abbreviated as N2). The UPF may establish a control plane signalling connection with the SMF through NG interface 4 (abbreviated as N4). The UPF may exchange user plane data with the data network through NG interface 6 (abbreviated as N6). The AMF may establish a control plane signalling connection with the SMF through NG interface 11 (abbreviated as N11). The SMF may establish a control plane signalling connection with the PCF through NG interface 7 (abbreviated as N7).

FIG. 1 exemplarily illustrates a base station, a core network device, and two terminal devices. Optionally, the wireless communication system 100 may include multiple base station devices, and other numbers of terminal devices may be included within the coverage of each base station, which is not limited by the embodiments of the disclosure.

It is to be noted that FIG. 1 only shows a system to which the disclosure applies by way of example, and of course, the method shown in the embodiments of the disclosure may be applied to other systems. In addition, the terms “system” and “network” may often be used interchangeably herein. The term “and/or” herein is only a description of an association relationship of associated objects, representing that there may be three kinds of relationships. For example, “A and/or B” may represent three conditions, i.e., independent existence of A, existence of both A and B, and independent existence of B. In addition, the character “/” herein usually represents that the previous and next associated objects are in an “or” relationship. It is further to be understood that the term “indicate” referred to in the embodiments of the disclosure may be a direct indication, an indirect indication, or may indicate an associated relationship. For example, “A indicates B” may mean that A directly indicates B, e.g., B may be obtained through A; or A indirectly indicates B, e.g., A indicates C and B may be obtained through C; or there is an associated relationship between A and B. It is further to be understood that the term “corresponding” referred to in the embodiments of the disclosure may represent a direct or indirect correspondence between the two, or may represent an associated relationship between the two, or a relationship between indicating and being indicated, configuring and being configured, or the like. It is further to be understood that the term “predefined” or “predefined rules” referred to in the embodiments of the disclosure may be achieved by storing in advance corresponding codes or forms in a device (e.g., including a terminal device and a network device), or other means that may be used to indicate relevant information. The specific implementation is not limited by the disclosure. For example, “predefined” may refer to being defined in a protocol. It is further to be understood that the “protocol” in the embodiments of the disclosure may refer to a standard protocol in the field of communication, which may include, for example, an LTE protocol, an NR protocol, and relevant protocols applied to future communication systems, which is not limited by the disclosure.

In order to facilitate understanding of the technical solutions of the embodiments of the disclosure, relevant technologies of the embodiments of the disclosure are illustrated below. The following relevant technologies, as optional solutions, may be arbitrarily combined with the technical solutions of the embodiments of the disclosure, all of which belong to the scope of protection of the embodiments of the disclosure.

The indication mechanism of the TCI state is only applicable to downlink channels and signals, and has many limitations when applied in NR systems. In order to provide a unified uplink and downlink beam management mechanism for NR systems, the 3GPP proposes the concept of unified TCI state. The unified TCI state adds important new features, for example, as follows.
Two modes of unified TCI states are designed.
A joint TCI state applies to uplink and downlink channels and signals.
A separate DL/UL TCI state, the DL TCI state only applies to downlink channels and signals, and the UL TCI state only applies to uplink channels and signals. In such mode, uplink and downlink beams may be controlled separately.
Downlink channels (Physical Downlink Control Channel (PDCCH) and Physical Downlink Shared Channel (PDSCH)) and signals (Non-periodic Channel State Information Reference Signal (CSI-RS)) use the same downlink transmission beam. The downlink transmission beam is indicated by the DL TCI state or joint TCI state.
Uplink channels (Physical Uplink Control Channel (PUCCH) and Physical Uplink Shared Channel (PUSCH)) and signals (Sounding Reference Signal (SRS)) use the same uplink transmission beam. The uplink transmission beam is indicated by the UL TCI state or joint TCI state.
The unified TCI state may be dynamically updated and indicated by a Media Access Control Control Element (MAC CE) and/or Downlink Control Information (DCI).
Applying to a carrier aggregation scenario, beam indication on a single Component Carrier (CC) may apply to multiple different CCs.
Uplink beam indication and uplink power control parameters may be given simultaneously through the UL TCI state or joint TCI state.
Inter-cell beam management functions are supported.

For the unified TCI state, there are several layers of meanings of “unified”. The first layer means that uplink and downlink beam indication mechanisms are unified. The TCI state is only used for downlink beam indication, and a signalling based on spatial relation information is used for the uplink beam indication. The second layer means beam unification of different channels. For example, under the configuration of the Separate DL/UL TCI state, the UE unifies the PDCCH (UE exclusive) and PDSCH (UE exclusive) into the same beam for transmission, and the UE transmits the PUCCH and PUSCH by the same beam. Under the configuration of the Joint TCI state, the UE considers that different channels and signals of uplink and downlink may have a good guarantee of beam symmetry, i.e., uses symmetric beam pairs for uplink and downlink to communicate.

RRC parameter configuration for the TCI state, the QCL and the unified TCI state may include the following.

| TCI-State ::= | SEQUENCE { | |
|---|---|---|
| tci-StateId | TCI-StateId, | |
| qcl-Type1 | QCL-Info, | |
| qcl-Type2 | QCL-Info | OPTIONAL, |

...
}

| QCL-Info ::= | SEQUENCE { | |
|---|---|---|
| cell | ServCellIndex | OPTIONAL, |

| | |
|---|---|
| bwp-Id | BWP-Id OPTIONAL, |
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

```
  ...,
  [[
```

| | | |
|---|---|---|
| additionalPCI-r17 | AdditionalPCIIndex-r17 | OPTIONAL |

]]
}

| DLorJoint-TCIState-r17 ::= | SEQUENCE { | |
|---|---|---|
| tci-StateUnifiedId-r17 | TCI-StateId, | |
| qcl-Type1-r17 | QCL-Info, | |
| qcl-Type2-r17 | QCL-Info | OPTIONAL, |

| | |
|---|---|
| ul-powerControl-r17 | Uplink-powerControlId-r17 OPTIONAL, |
| pathlossReferenceRS-Id-r17 | PUSCH-PathlossReferenceRS-Id OPTIONAL |

}

| UL-TCIState-r17 ::= | SEQUENCE { | |
|---|---|---|
| ul-TCIState-Id-r17 | UL-TCIState-Id-r17, | |
| servingCellId-r17 | ServCellIndex | OPTIONAL, |

| | |
|---|---|
| referenceSignal-r17 | CHOICE { |
| ssb-Index-r17 | SSB-Index, |
| csi-RS-Index-r17 | NZP-CSI-RS-ResourceId, |
| srs-r17 | PUCCH-SRS |

},

| | |
|---|---|
| additionalPCI-r17 | AdditionalPCIIndex-r17 OPTIONAL, |
| ul-powerControl-r17 | Uplink-powerControlId-r17 OPTIONAL, |
| pathlossReferenceRS-Id-r17 | PUSCH-PathlossReferenceRS-Id OPTIONAL |

Currently, the unified TCI state does not support Multiple TRP (Multi-TRP or mTRP).

Transmission solutions of mTRP are introduced as follows.

It is to be noted that in Release 17 (Rel. 17), the TCI state defined in Release 15 (Rel. 15) or Release 16 (Rel. 16) is used for mTRP transmission, instead of the unified TCI state defined in Rel. 17.

Transmission solution of Multi-TRP PDCCH

In Rel. 15, the NR supports the most basic PDCCH transmission, i.e. the sTRP PDCCH transmission manner. Here, configuration in the time domain is set, such as a Search Space Set (SSS), and a resource set where its associated control channel is located, i.e., a Control Resource Set (CORESET).

In Rel. 17, the NR supports a PDCCH repetition transmission solution of mTRP. In the same Release, a PDCCH System Frame Number (SFN) transmission manner is also supported.

In the PDCCH repetition transmission manner, the same PDCCH is transmitted from multiple TRPs by different beams in a manner of time-division multiplexing (TDM). As shown in FIG. 2, each of CORESET 1 corresponding to TRP1 and CORESET 2 corresponding to TRP2 has a respective activated beam direction, i.e., TCI state 1 and TCI state 2. Each of CORESET 1 and CORESET 2 has a respective associated Search Space Set, i.e., Search Space Set 1 and Search Space Set 2, which are directly associated through an RRC signalling. The UE receives PDCCH 1 from TRP1 by CORESET 1 and Search Space Set 1, and receives PDCCH 1 from TRP2 by CORESET 2 and Search Space Set 2. After PDCCH 1 from TRP 1 is received, it may be merged with PDCCH 1 from TRP 2, and then blind detection is performed and the PDCCH is decoded.

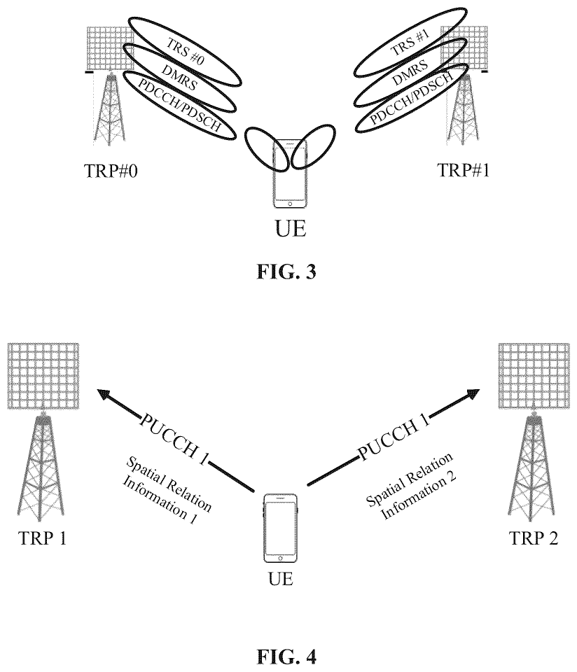

In the PDCCH SFN transmission manner, the same PDCCH or PDSCH is transmitted from multiple TRPs by different beams. As shown in FIG. 3, a Tracing Reference Signal (TRS) used to estimate Doppler frequency shift is transmitted in a TRP-exclusive manner, and different TRPs use different time or frequency domain resources to transmit the TRS. The PDCCH and PDSCH of the UE are transmitted through the SFN, that is to say, the NW uses the same time-frequency resources to send exactly the same PDCCH or PDSCH, only by different transmission beams since different TRPs have different spatial locations, i.e., the TCI states are different.

Unlike the sTRP PDCCH and PDCCH repetition transmission manners, for the CORESET(s) used in the PDCCH SFN transmission manner, two TCI states are required to be activated to be used respectively for different TRPs. The CORESETs of the sTRP PDCCH and PDCCH repetition transmission manners use only one TCI state.

### Transmission Solution of Multi-TRP PUCCH

In Rel. 17, the NR supports PUCCH mTRP-oriented TDM repetition transmission. The TDM here means that repetition transmission of the PUCCH does not overlap in time. Rel. 17 supports intra-slot and inter-slot repetition transmission. A PUCCH resource may have 1 or 2 Spatial Relation Information activated by the MAC CE, i.e. at most 2 uplink transmission beams. The UE determines whether to perform mTRP transmission according to the number of Spatial Relation Information of the used PUCCH resource.

In an example, when a PUCCH resource may have 2 Spatial Relation Information activated by the MAC CE, i.e., the Spatial Relation Information 1 and the Spatial Relation Information 2, as shown in FIG. 4, the UE sends PUCCHI to TRP1 by the uplink transmission beam indicated by Spatial Relation Information 1, and sends PUCCHI to TRP2 by the uplink transmission beam indicated by Spatial Relation Information 2.

### Transmission Solution of Multi-TRP PUCSH

Similarly, in the protocol of Rel. 17, inter-slot PUSCH mTRP-oriented repetition transmission is supported. The NW may configure at most 2 SRS resource sets, and indicate one or two SRS resource sets in the uplink scheduling DCI to inform the UE whether to perform sTRP PUSCH or mTRP PUSCH transmission. Here, an SRS resource set corresponds to a TRP. In the uplink scheduling DCI, the NW further indicates a particular SRS resource in the indicated SRS resource set. The UE sends the PUSCH according to the beam direction within the nearest slot of the particular SRS resource.

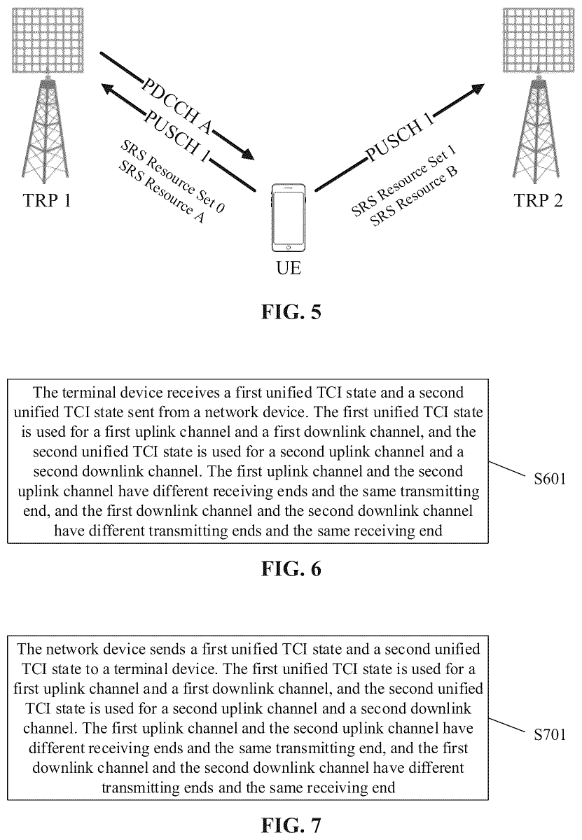

In order to better illustrate the PUSCH repetition, as shown in FIG. 5, two SRS resource sets, SRS resource set 0 and SRS resource set 1, are indicated in the DCI of PDCCH A. SRS resource set 0 corresponds to TRP 1 and SRS resource set 1 corresponds to TRP 2. The UE sends PUSCHI to TRP1 through the selected SRS resource A in SRS resource set 0, and sends PUSCHI to TRP2 through the selected SRS resource B in SRS resource set 1.

If the unified TCI state is directly applied to the multi-TRP scenario, there is a problem needed to be solved. That is, the unified TCI state has a strong integration capability within a CC/Bandwidth Part (BWP), i.e., the unified TCI state integrates the downlink PDCCH/PDSCH/CSI-RS, the uplink PUCCH/PUSCH/SRS, or the like onto the same beam. However, the unified TCI state is for a TRP, which requires only one set of uplink and downlink beams. But in the mTRP scenario, at least two sets of independent uplink and downlink beams are required to correspond to spatially separated TRPs.

Therefore, if 1 or 2 unified TCI state(s) is/are indicated in the MAC CE or MAC CE+DCI signalling, how to allocate the indicated unified TCI state(s) when mTRP transmission is performed on uplink and downlink channels is a problem to be solved.

In order to facilitate understanding of the technical solutions of the embodiments of the disclosure, the technical solutions of the disclosure are described in detail below by specific embodiments. The above relevant technologies, as optional solutions, may be arbitrarily combined with the technical solutions of the embodiments of the disclosure, all of which belong to the scope of protection of the embodiments of the disclosure. The embodiments of the disclosure include at least some of the following.

A wireless communication method applied to a terminal device provided by an embodiment of the disclosure, as shown in FIG. 6, includes the following operation.

In operation S601, the terminal device receives a first unified TCI state and/or a second unified TCI state sent from a network device. The first unified TCI state is used for a first uplink channel/signal and/or a first downlink channel/signal, and the second unified TCI state is used for a second uplink channel/signal and/or a second downlink channel/signal. The first uplink channel/signal and the second uplink channel/signal have different receiving ends and the same transmitting end, and the first downlink channel/signal and the second downlink channel/signal have different transmitting ends and the same receiving end.

A wireless communication method applied to a network device provided by an embodiment of the disclosure, as shown in FIG. 7, includes the following operation.

In operation S701, the network device sends a first unified TCI state and/or a second unified TCI state to a terminal device. The first unified TCI state is used for a first uplink channel/signal and/or a first downlink channel/signal, and the second unified TCI state is used for a second uplink channel/signal and/or a second downlink channel/signal. The first uplink channel/signal and the second uplink channel/signal have different receiving ends and the same transmitting end, and the first downlink channel/signal and the second downlink channel/signal have different transmitting ends and the same receiving end.

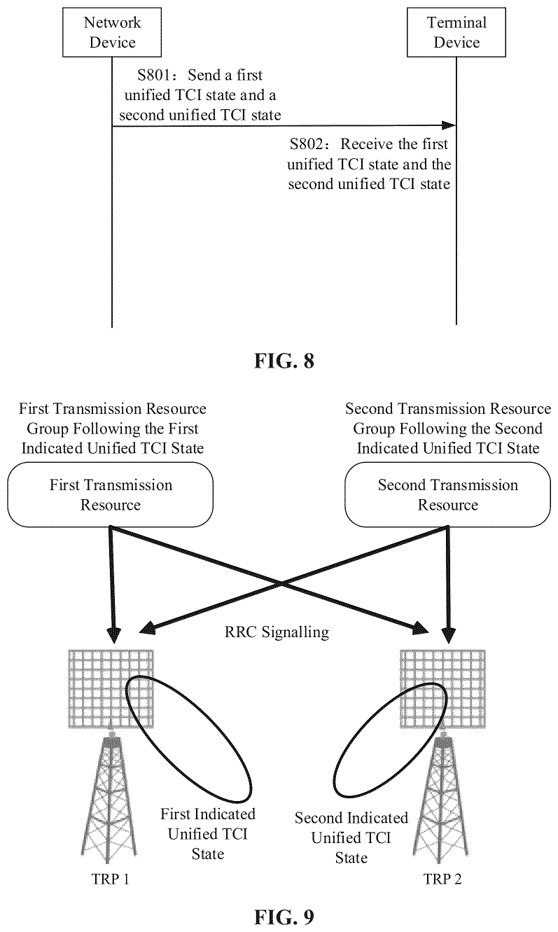

A wireless communication method applied to a wireless communication system provided by an embodiment of the disclosure, as shown in FIG. 8, includes the following operations.

In operation S801, a network device sends a first unified TCI state and a second unified TCI state to a terminal device.

In operation S802, the terminal device receives the first unified TCI state and the second unified TCI state.

The first unified TCI state is used for a first uplink channel/signal and/or a first downlink channel/signal, and the second unified TCI state is used for a second uplink channel/signal and/or a second downlink channel/signal. The first uplink channel/signal and the second uplink channel/signal have different receiving ends and the same transmitting end, and the first downlink channel/signal and the second downlink channel/signal have different transmitting ends and the same receiving end.

In the following, the wireless communication method shown in FIG. 6, FIG. 7 or FIG. 8 is illustrated.

In the embodiments of the disclosure, the network device may configure multiple unified TCI states for the terminal device. The network device may activate a unified TCI state selected from the configured multiple unified TCI states for the terminal device, and the activated unified TCI state is a part of the configured unified TCI states. When the number of activated unified TCI states is greater than the number of TRPs, the network device indicates to the terminal device one or more unified TCI states selected from the activated TCI states. The indicated TCI state is used for the TRP for transmission, and different TRPs correspond to different indicated unified TCI states.

Optionally, the network device configures the unified TCI state through a Radio Resource Control (RRC) signalling.

Optionally, the network device activates the unified TCI state through an MAC CE.

Optionally, the network device indicates the unified TCI state through DCI.

The first unified TCI state and the second unified TCI state are two different unified TCI states, i.e., indicated unified TCI states, of the unified TCI states indicated by the network device.

Optionally, when the two unified TCI states are indicated through the same signalling, the first unified TCI state is the indicated unified TCI state firstly discovered by the terminal device, and the second unified TCI state is the indicated unified TCI state secondly discovered by the terminal device.

It is to be understood that the first unified TCI state and the second unified TCI state may be unified TCI states activated through the MAC CE or unified TCI states indicated through the DCI.

In the embodiments of the disclosure, the first unified TCI state is used for the first uplink channel/signal and/or the first downlink channel/signal, and the second unified TCI state is used for the second uplink channel/signal and/or the second downlink channel/signal.

It is to be understood that the first uplink channel/signal is an uplink channel/signal sent from the terminal device to a first TRP, the first downlink channel/signal is a downlink channel/signal sent from the first TRP to the terminal device, the second uplink channel/signal is an uplink channel/signal sent from the terminal device to a second TRP, and the second downlink channel is a downlink channel/signal sent from the second TRP to the terminal device.

Optionally, the uplink channel includes at least one of a PUCCH or a PUSCH, and the uplink signal includes a CSI-RS.

Optionally, the downlink channel includes at least one of a PDCCH or a PDSCH, and the downlink signal includes an SRS.

The terminal device sends the first uplink channel/signal and receives the first downlink channel/signal by a first beam indicated by the first unified TCI state, and sends the second uplink channel/signal and receives the second downlink channel/signal by a second beam indicated by the second unified TCI state.

It is to be understood that the terminal device performs uplink communication and downlink communication with the first TRP by the first beam, and the terminal device performs uplink communication and downlink communication with the second TRP by the second beam.

In the embodiments of the disclosure, the number of TRPs in the mTRP scenario is a first number, and the first number is greater than or equal to 2.

In the mTRP scenario, the number of unified TCI states sent from the network device is the first number, such that different TRPs communicate with the terminal device by different beams.

Optionally, the network device further indicates a third unified TCI state. The third TCI state is used for a third uplink channel/signal and/or a third downlink channel/signal.

Optionally, the network device further indicates a fourth unified TCI state. The fourth TCI state is used for a fourth uplink channel/signal and/or a fourth downlink channel/signal.

In the embodiments of the disclosure, in the mTRP scenario, different TRPs use different unified TCI states. For the same TRP, the uplink channel including the PUCCH and/or the PUSCH and/or the downlink channel including the PDCCH and/or the PDSCH use one unified TCI state, thereby achieving the use of unified TCI states in the mTRP scenario.

Optionally, for a TRP, the unified TCI state corresponding to the TRP may be associated with a channel of the TRP, and other channels follow the unified TCI state associated with the channel.

In an example, a first PDCCH of the first TRP is associated with the first unified TCI state, and a first PDSCH, a first PUCCH, and a first PUSCH of the first TRP follow the first unified TCI state associated with the first PDCCH.

In an example, the first PUSCH of the first TRP is associated with the first unified TCI state, and the first PDSCH, the first PUCCH, and the first PDCCH of the first TRP follow the first unified TCI state associated with the first PUSCH.

Optionally, for a TRP, the unified TCI state corresponding to the TRP may be associated with multiple channels of the TRP.

In an example, the first PDSCH, the first PUCCH, the first PDCCH, and the first PUSCH of the first TRP are respectively associated with the first unified TCI state.

With the wireless communication method provided by the embodiment of the disclosure, the first unified TCI state sent from the network device to the terminal device is allocated to the first uplink channel/signal and/or the first downlink channel/signal, and the second unified TCI state sent from the network device to the terminal device is allocated to the second uplink channel/signal and/or the second downlink channel/signal, such that channels/signals of different TRPs operating in the mTRP scenario achieve spatial isolation based on different unified TCI states.

In some embodiments, the first unified TCI state includes a first joint TCI state, and the second unified TCI state includes a second joint TCI state. The first joint TCI state is used for the first downlink channel/signal and the first uplink channel/signal, and the second joint TCI state is used for the second uplink channel/signal and the second downlink channel/signal.

In some embodiments, the first united TCI state includes a first separate uplink TCI state and a first separate downlink TCI state, and the second united TCI state includes a second separate uplink TCI state and a second separate downlink TCI state. The first separate downlink TCI state is used for the first downlink channel/signal, and the first separate uplink TCI state is used for the first uplink channel/signal. The second separate downlink TCI state is used for the second downlink channel/signal, and the second separate uplink TCI state is used for the second uplink channel/signal.

The beam indicated by the first separate uplink TCI state and the beam indicated by the first separate downlink TCI state may be the same beam or different beams. Similarly, the beam indicated by the second separate uplink TCI state and the beam indicated by the second separate downlink TCI state may be the same beam or different beams.

In an example, the first separate uplink TCI state indicates beam A, the second separate uplink TCI state indicates beam B, the first separate downlink TCI state indicates beam B, and the second separate downlink TCI state indicates beam A.

In an example, the first separate uplink TCI state indicates beam A, the second separate uplink TCI state indicates beam B, the first separate downlink TCI state indicates beam A, and the second separate downlink TCI state indicates beam B.

In some embodiments, the first unified TCI state is associated with a first transmission resource or a first transmission resource group to which the first transmission resource belongs, and the second unified TCI state is associated with a second transmission resource or a second transmission resource group to which the second transmission resource belongs. The first transmission resource is a transmission resource associated with the first uplink channel/signal or the first downlink channel/signal, and the second transmission resource is a transmission resource associated with the second uplink channel/signal or the second downlink channel/signal.

The first transmission resource is a transmission resource corresponding to the first TRP, and is used for the first TRP to perform transmission of channels or signals with the terminal device. The first transmission resource is associated with the first unified TCI state, i.e., the first transmission resource follows the first unified TCI state, and the first TRP performs the transmission of channels or signals with the terminal device by the first beam. The second transmission resource is a transmission resource corresponding to the second TRP, and is used for the second TRP to perform transmission of channels or signals with the terminal device. The second transmission resource is associated with the second unified TCI state, i.e., the second transmission resource follows the second unified TCI state, and the second TRP performs the transmission of channels or the signals with the terminal device by the second beam.

In the embodiments of the disclosure, the first transmission resource includes a first uplink transmission resource or a first downlink transmission resource. The first uplink transmission resource is associated with the first uplink channel/signal, and the first downlink transmission resource is associated with the first downlink channel/signal. The second transmission resource includes a second uplink transmission resource or a second downlink transmission resource. The second uplink transmission resource is associated with the second uplink channel/signal, and the second downlink transmission resource is associated with the second downlink channel/signal.

The transmission resource group to which the first transmission resource belongs is the first transmission resource group, and the transmission resource group to which the second transmission resource belongs is the second transmission resource group.

Different transmission resource groups correspond to different TRPs. The first transmission resource group corresponds to the first TRP, and is a transmission resource group consisting of transmission resources that may be used by the first uplink channel or the first downlink channel of the first TRP. The second transmission resource group corresponds to the second TRP, and is a transmission resource group consisting of transmission resources that may be used by the second uplink channel/signal or the second downlink channel/signal of the second TRP.

In the embodiments of the disclosure, allocation of the unified TCI states is performed in units/granularity of transmission resources or transmission resource groups.

Optionally, the transmission resource is a time domain and/or frequency domain resource.

Optionally, the first transmission resource is the same or different from the second transmission resource.

When the first transmission resource and the second transmission resource are different, the first transmission resource and the second transmission resource are respectively associated with the first unified TCI state and the second unified TCI state. Then, the first TRP using the first unified TCI state and the second TRP using the second unified TCI state receive uplink channels by different time-frequency resources, or send downlink channels by different time-frequency resources.

In an example, the first TRP using the first beam and the second TRP using the second beam send PDCCHs by different time-frequency resources.

In an example, the first TRP using the first beam and the second TRP using the second beam receive PUSCHs by different time-frequency resources.

In an example, the first TRP using the first beam and the second TRP using the second beam receive PUCCHs by different time-frequency resources.

When the first transmission resource and the second transmission resource are the same, the first transmission resource and the second transmission resource are associated with the first unified TCI state and the second unified TCI state. Then, the first TRP using the first unified TCI state and the second TRP using the second unified TCI state receive uplink channels/signals by the same time-frequency resource, or send downlink channels/signals by the same time-frequency resource.

In an example, the first TRP using the first beam and the second TRP using the second beam send PDCCHs by the same time-frequency resource.

In an example, the first TRP using the first beam and the second TRP using the second beam send PDSCHs by the same time-frequency resource.

In an example, the first TRP using the first beam and the second TRP using the second beam receive PUCCHs by the same time-frequency resource.

In some embodiments, the transmission resource includes at least one of a PDCCH resource, a CORESET, an SSS, a PDSCH resource, a PUSCH resource, an SRS resource, a transmission occasion, a PUCCH resource, or a CSI-RS resource.

The PDCCH resource is associated with the PDCCH, the CORESET is associated with the PDCCH or PDSCH, the SSS is associated with the PDCCH or PDSCH, the PDSCH resource is associated with the PDSCH, the SRS resource set is associated with the PUSCH or SRS, the PUSCH resource is associated with PUSCH, the transmission occasion is associated with the PUSCH, the PUCCH resource is associated with the PUCCH, and the CSI-RS resource is associated with the CSI-RS.

In the embodiments of the disclosure, an association relationship between the first unified TCI state and the first transmission resource may be referred to as a first association relationship, and an association relationship between the second unified TCI state and the second transmission resource may be referred to as a second association relationship. The configuration manner of the first association relationship and the second association relationship includes at least one of the following manners.

In a first manner, they are configured by the network device.

In a second manner, they are configured by the terminal device.

A case, in which the configuration manner of the first association relationship and the second association relationship is the first manner, is taken as an example.

The first association relationship is configured by first information sent from the network device, and the second association relationship is configured by second information sent from the network device.

The operation that the terminal device receives the first unified TCI state and the second unified TCI state sent from the network device includes the following operation. The terminal device receives the first information and the second information sent from the network device. The first information indicates the first association relationship, and the second information indicates the second association relationship. The first association relationship is the association relationship between the first unified TCI state and the first transmission resource, and the second association relationship is the association relationship between the second unified TCI state and the second transmission resource.

In such case, the operation that the network device sends the first unified TCI state and the second unified TCI state to the terminal device includes the following operation. The network device sends the first information and the second information to the terminal device. The first information indicates the first association relationship, and the second information indicates the second association relationship. The first association relationship is the association relationship between the first unified TCI state and the first transmission resource, and the second association relationship is the association relationship between the second unified TCI state and the second transmission resource.

It is to be understood that in the first manner, the network device configures the first association relationship and the second association relationship for the terminal device directly through the first information and the second information.

In some embodiments, the first information includes first configuration information for the first transmission resource or the first transmission resource group. The second information includes second configuration information for the second transmission resource or the second transmission resource group. The first configuration information includes the first unified TCI state, and the second configuration information includes the second unified TCI state.

Optionally, configuration information of a transmission resource includes resource identification of the transmission resource, configuration information of a transmission resource group includes group identification of the transmission resource group, and the configuration information of the transmission resource or the transmission resource group further includes a unified TCI state followed by or associated with the transmission resource or the transmission resource group.

In some embodiments, the first information and/or the second information is transmitted through a first signalling. The first signalling includes at least one of:
an RRC signalling;
an MAC CE; or
DCI.

Optionally, the first information and the second information may be indicated through the same first signalling or two separate first signallings.

Here, if the first information and the second information are indicated through the same first signalling, the first signalling transmits the first information and the second information. The first signalling indicates the first association relationship and the second association relationship simultaneously. If the first information and the second information are transmitted through different first signallings, a first signalling includes only the first information or the second information, and the first association relationship and the second association relationship are respectively indicated through different first signallings.

Optionally, the first transmission resource and the second transmission resource are the same. Then, the first information and the second information may be the same information, and the first association relationship and the second association relationship are indicated through the same first signalling.

Optionally, the first transmission resource and the second transmission resource are different. Then, the first information and the second information are different information, and the first information and the second information may be indicated through the same first signalling.

Optionally, the first transmission resource and the second transmission resource are different. Then, the first information and the second information are different information, and the first information and the second information may be respectively indicated through two different first signallings.

Taking a case where the first signalling includes the RRC signalling as an example, the network device pre-configures the first association relationship and/or the second association relationship through the RRC signalling. It is to be understood that the pre-configuration of the first association relationship and the second association relationship based on the RRC signalling is a static solution.

Taking a case where the first signalling includes the MAC CE as an example, the network device indicates or updates the first association relationship and/or the second association relationship through the MAC CE.

Taking a case where the first signalling is the DCI as an example, the network device dynamically schedules the first association relationship and/or the second association relationship through the DCI. The DCI may be used to schedule at least one of the first uplink channel, the first downlink channel, the second uplink channel, or the second downlink channel.

In some embodiments, a first association relationship indicated by the first information transmitted through the MAC CE and/or a second association relationship indicated by the second information transmitted through the MAC CE is used to update an existing first association relationship and/or an existing second association relationship.

The MAC CE may be used to indicate the first association relationship and the second association relationship.

When the terminal device has the existing first association relationship and the existing second association relationship, the MAC CE may be used to update one or two of the existing first association relationship and the existing second association relationship. The existing first association relationship and the second existing association relationship may be determined by the first manner or the second manner.

In some embodiments, the MAC CE includes at least one of first indicative information, second indicative information, third indicative information or fourth indicative information.

The first indicative information is configured to indicate a serving cell.

The second indicative information is configured to indicate a BWP.

The third indicative information is configured to indicate a target transmission resource or a target transmission resource group. The target transmission resource is the first transmission resource or the second transmission resource, and the target transmission resource group is the first transmission resource group or the second transmission resource group.

The fourth indicative information is configured to indicate a target unified TCI state associated with the target transmission resource or the target transmission resource group.

Optionally, the first indicative information is serving cell identification.

Optionally, the second indicative information is BWP identification.

For the third indicative information, when the transmission resource is associated with the unified TCI state, the third indicative information indicates the transmission resource. When the transmission resource group is associated with the unified TCI state, the third indicative information indicates the transmission resource group.

In the embodiments of the disclosure, the first indicative information to the fourth indicative information form a group of information sets for a transmission resource or a transmission resource group. One or more groups of information sets may be included in the MAC CE.

In some embodiments, the DCI includes a first domain of the target transmission resource or the target transmission resource group. The first domain includes fifth indicative information, and the fifth indicative information is configured to indicate the target unified TCI state associated with the target transmission resource or the target transmission resource group.

The DCI schedules one or more transmission resources. When scheduling one transmission resource, the DCI may include a newly defined first domain. When scheduling multiple transmission resources, the DCI may include multiple newly defined first domains, and different first domains are for different transmission resources.

In some embodiments, the target unified TCI state includes one of:
the first unified TCI state;
the second unified TCI state;
the first unified TCI state and the second unified TCI state; or
a reserved state.

In the embodiments of the disclosure, the fourth indicative information and the fifth indicative information are information indicating the same content.

The fourth indicative information or the fifth indicative information may be a customized codepoint. The customized codepoint may be used to indicate one of: the first unified TCI state, the second unified TCI state, the first unified TCI state and the second unified TCI state, or the reserved state.

When the target unified TCI state includes the first unified TCI state or the second unified TCI state, the target transmission resource or the target transmission resource group is associated with the first unified TCI state or the second unified TCI state. In such case, the first transmission resource and the second transmission resource are different, and the first transmission resource group and the second transmission resource group are different.

When the target unified TCI state includes the first unified TCI state and the second unified TCI state, the target transmission resource or the target transmission resource group is associated with the first unified TCI state and the second unified TCI state, and the first transmission resource and the second transmission resource are the same.

In an example, the fourth indicative information, which corresponds to the third indicative information in the MAC CE indicating transmission resource A, indicates the first unified TCI state, and the fourth indicative information, which corresponds to the third indicative information in the MAC CE indicating transmission resource B, indicates the second unified TCI state. Then, transmission resource A follows the first unified TCI state and transmission resource B follows the second unified TCI state.

In an example, the fourth indicative information, which corresponds to the third indicative information in the MAC CE indicating transmission resource C, indicates the first unified TCI state and the second unified TCI state. Then, transmission resource C follows the first unified TCI state and the second unified TCI state.

In an example, first domain A in the DCI is for the first transmission resource or the first transmission resource group, and first domain B is for the second transmission resource or the second transmission resource group. A codepoint in first domain A indicates the first unified TCI state, and a codepoint in first domain B indicates the second unified TCI state. Then, the first transmission resource or the first transmission resource group follows the first unified TCI state, and the second transmission resource or the second transmission resource group follows the second unified TCI state.

In an example, first domain C in the DCI is for the first transmission resource, and a codepoint in first domain C indicates the first unified TCI state and the second unified TCI state. Then, the first transmission resource and the second transmission resource are the same, and the transmission resource follows the first unified TCI state and the second unified TCI state.

In some embodiments, if the target transmission resource belongs to a downlink transmission resource or the target transmission resource group belongs to a downlink transmission resource group, and the target unified TCI state is the reserved state, the target transmission resource or the target transmission resource group is associated with a TCI state.

Optionally, when the first transmission resource and the second transmission resource are the same, the terminal device does not wish the target transmission state to include the first unified TCI state or the second unified TCI state.

For the second manner, the terminal device associates the first unified TCI state indicated by the network device with the first transmission resource, and associates the second unified TCI state indicated by the network device with the second transmission resource.

For the first transmission resource of the first TRP and the second transmission resource of the second TRP, the network device indicates the first unified TCI state and the second unified TCI state.

Optionally, the network device indicates one of the first unified TCI state or the second unified TCI state for the target transmission resource, and the target transmission resource is the first transmission resource or the second transmission resource. Then, the target transmission resource is associated with the indicated TCI state.

Optionally, the network device indicates the first unified TCI state and the second unified TCI state for the target transmission resource. Then, the target transmission resource is associated with one or two of the indicated TCI states.

The first transmission resource and the second transmission resource are different, the first transmission resource is associated with the first unified TCI state, and the second transmission resource is associated with the second unified TCI state. The first transmission resource and the second transmission resource are the same, and the transmission resource is associated with the first unified TCI state and the second unified TCI state.

The network device may indicate the first unified TCI state and the second unified TCI state through a second signalling. The second signalling includes at least one of:
an MAC CE; or
DCI.

The MAC CE is used to activate the unified TCI state, and the DCI is used to indicate the unified TCI state. When the number of activated TCI states is the same as the number of TRPs, the activated unified TCI state may be understood as the indicated unified TCI state.

Optionally, the first unified TCI state and the second unified TCI state may be indicated through the same second signalling or may be indicated through different second signallings.

In some embodiments, the terminal device does not expect the network device to indicate one unified TCI state.

When the network device indicates only one unified TCI state, the UE is indicated to use only one beam. In such case, spatial isolation can not be performed on different mTRPs in the mTRP scenario.

If the network device indicates only one unified TCI state, the terminal device may assume that the network device indicates an error and it is currently in an Error Case. The UE does not expect such case to happen.

Based on different channels, the wireless communication method provided by the embodiment of the disclosure may be applied to the following cases.

In a first case, the first downlink channel is the first PDCCH, and the second downlink channel is a second PDCCH.

In a second case, the first downlink channel is the first PDSCH, and the second downlink channel is a second PDSCH.

In a third case, the first uplink channel is the first PUSCH, and the second uplink channel is a second PUSCH.

In a fourth case, the first uplink channel is the first PUCCH, and the second uplink channel is a second PUCCH.

In the first case, the first TRP sends the first PDCCH to the terminal device through the first beam, and the second TRP sends the second PDCCH to the terminal device through the second beam. The terminal device receives the first PDCCH sent from the first TRP through the first beam, and receives the second PDCCH sent from the second TRP through the second beam.

The transmission resource associated with the PDCCH includes the CORESET or the SSS. The unified TCI state may be associated with at least one of the CORESET, the SSS, a CORESET group, or a SSS group.

Optionally, the CORESET and the SSS are in an one-to-one correspondence.

A first CORESET used by the first PDCCH and a second CORESET used by the second PDCCH are the same or different. When the first CORESET and the second CORESET are different, the transmission mode of the PDCCH is PDCCH repetition transmission. When the first CORESET and the second CORESET are the same, the transmission mode of the PDCCH is PDCCH SFN transmission.

Optionally, if the first downlink channel is the first PDCCH and the second downlink channel is the second PDCCH, the first CORESET, which is associated with the first PDCCH, is associated with the first unified TCI state, and the second CORESET, which is associated with the second PDCCH, is associated with the second unified TCI state.

Optionally, if the first downlink channel is the first PDCCH and the second downlink channel is the second PDCCH, a first CORESET group, which is associated with the first PDCCH, is associated with the first unified TCI state, and a second CORESET group, which is associated with the second PDCCH, is associated with the second unified TCI state.

The first CORESET group includes at least one CORESET that can be occupied by the first PDCCH, and the second CORESET group includes at least one CORESET that can be occupied by the second PDCCH.

In the embodiments of the disclosure, the first CORESET group is a CORESET group consisting of CORESETs that may be occupied by the first PDCCH sent from the first TRP, and the second CORESET group is a CORESET group consisting of CORESETs that may be occupied by the second PDCCH sent from the second TRP. The first CORESET group and the second CORESET group may be configured by the network device through the RRC signalling.

Optionally, if the first downlink channel is the first PDCCH and the second downlink channel is the second PDCCH, a first SSS is associated with the first unified TCI state, and a second SSS is associated with the second unified TCI state. The first SSS is associated with the first CORESET which is associated with the first PDCCH, and the second SSS is associated with the second CORESET which is associated with the second PDCCH.

Optionally, if the first downlink channel is the first PDCCH and the second downlink channel is the second PDCCH, a first SSS group is associated with the first unified TCI state, and a second SSS group is associated with the second unified TCI state. The first SSS group is associated with the first CORESET group which is associated with the first PDCCH, and the second SSS group is associated with the second CORESET group which is associated with the second PDCCH.

In some embodiments, the first SSS group includes each SSS associated with a respective COREST in the first CORESET group, and the second SSS group includes each SSS associated with a respective COREST in the second CORESET group.

Here, the SSSs included in the first SSS group and the CORESETs included in the first CORESET group are in an one-to-one correspondence, and the SSSs included in the second SSS group and the CORESETs included in the second CORESET group are in an one-to-one correspondence.

In some embodiments, a first channel or a first signal scheduled by the first PDCCH is associated with the first unified TCI state, and a second channel or a second signal scheduled by the second PDCCH is associated with the second unified TCI state.

A channel that may be scheduled by the PDCCH may include at least one of the PDSCH, the PUCCH, or the PUSCH.

Optionally, in a multi-DCI scenario, i.e., when channels of different TRPs are scheduled by different PDCCHs, the first channel or the first signal scheduled by the first PDCCH is associated with the first unified TCI state, and the second channel or the second signal scheduled by the second PDCCH is associated with the second unified TCI state.

Optionally, the first channel includes the first PDSCH and the second channel includes the second PDSCH; and/or
the first channel includes the first PUSCH and the second channel includes the second PUSCH; and/or
the first channel includes the first PUCCH and the second channel includes the second PUCCH.

A signal that may be scheduled by the PDCCH may include at least one of the CSI-RS or the SRS. The CSI-RS may be a periodic CSI-RS, a semi-sustained CSI-RS or a non-periodic CSI-RS. The SRS may be a periodic SRS, a semi-sustained SRS or a non-periodic SRS

Optionally, the first signal includes a first CSI-RS and the second signal includes a second CSI-RS; and/or, the first signal includes a first SRS and the second signal includes a second SRS.

In the second case, the first TRP sends the first PDSCH to the terminal device through the first beam, and the second TRP sends the second PDSCH to the terminal device through the second beam. The terminal device receives the first PDSCH sent from the first TRP through the first beam, and receives the second PDSCH sent from the second TRP through the second beam.

The first CORESET used by the first PDSCH and the second CORESET used by the second PDSCH are the same CORESET.

Optionally, the first downlink channel is the first PDSCH and the second downlink channel is the second PDSCH. The first PDSCH is associated with the first COREST, and the second PDSCH is associated with the first COREST. The first COREST is associated with the first unified TCI state and the second unified TCI state.

The terminal device receives the first TRP and the second TRP and sends the first PDSCH and the second PDSCH by different beams on the same time-frequency resource.

Optionally, the first unified TCI state and the second unified TCI state are associated with all CORESTs used by the terminal device to transmit a PDSCH.

Here, the terminal device receives the first PDSCH sent from the first TRP by the first beam and receives the second PDSCH sent from the second TRP by the second beam on a respective time-frequency resource associated with each CORESET.

In the embodiments of the disclosure, the terminal device may not be concerned with whether the transmission manner of DCI scheduling is sTRP or mTRP, such that reception of all PDSCHs is performed by the first unified TCI state and the second unified TCI state.

In the third case, the first TRP receives the first PUSCH sent from the terminal device through the first beam, and the second TRP receives the second PUSCH sent from the terminal device through the second beam. The terminal device sends the first PUSCH to the first TRP through the first beam, and sends the second PUSCH to the second TRP through the second beam.

Optionally, the first uplink channel is the first PUSCH and the second uplink channel is the second PUSCH, and the obtaining manner of the first association relationship and the second association relationship is the first manner. Optionally, the first signalling includes the RRC signalling, the MAC CE and uplink DCI.

The first PUSCH and the second PUSCH are associated with different transmission resources.

The transmission resource associated with the PUSCH includes at least one of the SRS resource set or the transmission opportunity. The first PUSCH is associated with a first SRS resource set and/or a first transmission opportunity, and the second PUSCH is associated with a second SRS resource set and/or a second transmission opportunity.

Optionally, the first uplink channel is the first PUSCH and the second uplink channel is the second PUSCH. The first SRS resource set, which is associated with the first PUSCH, is associated with the first unified TCI state, and the second SRS resource set, which is associated with the second PUSCH, is associated with the second unified TCI state.

Optionally, the first uplink channel is the first PUSCH and the second uplink channel is the second PUSCH. The first transmission opportunity, which is associated with the first PUSCH, is associated with the first unified TCI state, and the second transmission opportunity, which is associated with the second PUSCH, is associated with the second unified TCI state.

In the embodiments of the disclosure, when the number of times of PUSCH repetitions is greater than a first number, the first number of transmission opportunities are a cycle. Within a cycle, the first number of transmission opportunities are respectively associated with a respective different unified TCI state of the first number of unified TCI states.

In the fourth case, the first TRP receives the first PUCCH sent from the terminal device through the first beam, and the second TRP receives the second PUCCH sent from the terminal device through the second beam. The terminal device sends the first PUCCH to the first TRP through the first beam, and sends the second PUCCH to the second TRP through the second beam.

PUCCHs on different TRPs use the same or different transmission resources.

Here, the transmission resource associated with the PUCCH is the PUCCH resource.

Optionally, the PUCCH resource is used to carry at least one of a Hybrid Automatic Repeat reQuest (HARQ), CSI, or an SR.

Optionally, the first uplink channel is the first PUCCH and the second uplink channel is the second PUCCH. A first PUCCH resource group, in which a first PUCCH resource associated with the first PUCCH is located, is associated with the first unified TCI state. A second PUCCH resource group, in which a second PUCCH resource associated with the second PUCCH is located, is associated with the second unified TCI state.

The PUCCH resource is associated with the unified TCI state based on the PUCCH resource group.

Optionally, the first PUCCH resource being associated with the first unified TCI state is used to determine that the first PUCCH resource group is associated with the first unified TCI state. The second PUCCH resource being associated with the second unified TCI state is used to determine that the second PUCCH resource group is associated with the second unified TCI state.

Optionally, the first unified TCI state and the second unified TCI state are associated with all PUCCH resources on a first CC or a first BWP. The first CC or the first BWP is a CC or a BWP applicable to the first unified TCI state and the second unified TCI state.

In some embodiments, the terminal device receives a third unified TCI state sent from the network device. The third unified TCI state is used for the first uplink channel/signal and/or the first downlink channel/signal, or the third unified TCI state is used for the second uplink channel/signal and/or the second downlink channel/signal.

Here, the third unified TCI state is the first unified TCI state or the second unified TCI state, or a unified TCI state other than the first unified TCI state and the second unified TCI state.

When the network device indicates one unified TCI state, the terminal device performs single TRP transmission based on the unified TCI state, i.e., communicates with one TRP.

In the following, the wireless communication method provided by the embodiments of the disclosure is further described.

With the wireless communication method provided by the embodiments of the disclosure, when the UE is configured and indicated with one or more unified TCI states and the UE operates in the mTRP scenario, how each of different uplink and downlink channels uses the indicated unified TCI state.

For the PDCCH, the PDCCH transmits control information and is responsible for scheduling uplink and downlink data channels, i.e., DCI format 1_1/1_2 is used to schedule the downlink data channel PDSCH and DCI format 0_1/0_2 is used to schedule the uplink data channel PUSCH.

Subsequently, beam indication conditions of the scheduled PDSCH and PUSCH are considered.

For the PUCCH, since some PUCCH resources are used by downlink scheduling DCI, the PUCCH is used to carry HARQ-ACK information of the scheduled PDSCH. However, there are also some PUCCHs that are used by the UE in a semi-static manner, for example, a PUCCH that carries Periodic (P)/Semi-Permanent (SP) CSI, or a PUCCH that is triggered by the UE itself to carry a Scheduling Request (SR).

Finally, for different channels and combinations (e.g., PDCCH SFN transmission and sTRP PDSCH), where the former belongs to mTRP transmission and the latter belongs to sTRP transmission, we allow the existence of such combinations. This is because the existence of such scheduling flexibility is needed in the NR system. However, for one or more indicated unified TCI states, the effect of the wireless communication method provided by the embodiments of the disclosure is as follows. Channels from the same TRP, such as PDCCH and PDSCH, use the same downlink transmission beam. For channels sent to the same TRP, such as PUCCH and PUSCH, the UE uses the same uplink transmission beam. The same beam here is only for TRP-specific. It is not required that the beams of PDCCH and PDSCH are identical from the perspective of cell-specific.

For one or more unified TCI states indicated/updated in S-DCI, since codepoints are activated based on the MAC CE, each codepoint may correspond to one or two unified TCI states. When a codepoint includes two unified TCI states, the unified TCI states appear in the MAC CE in an order. We may consider that (when the MAC CE is read from top to bottom) the unified TCI state appearing firstly is the first one, and the unified TCI state appearing secondly is the second one.

For unified TCI states indicated/updated in M-DCI, a unified TCI state is indicated in each piece of DCI. Therefore, the embodiments of the disclosure provide the following definition as a basis for the subsequent solution.

When a serving cell is configured with a Joint TCI state pool, it is agreed that the MAC CE may activate a first Joint TCI state (corresponding to a first TRP) and a second Joint TCI state (corresponding to a second TRP).

If the serving cell is configured with separate DL/UL TCI state pools, the MAC CE may activate a first DL TCI state and a first UL TCI state (corresponding to the first TRP), and a second DL TCI state and a second UL TCI state (corresponding to the second TRP).

### Embodiment 1: Indication/Update for the Unified TCI State of the PDCCH

For different PDCCH transmission manners, basic sTRP PDCCH transmission, as well as enhanced PDCCH Repetition and SFN PDCCH in Rel. 17 are supported in previous NR releases. The embodiments of the disclosure try to process different PDCCH transmission solutions according to a unified manner, but also take into account differences in beams used for each transmission manner.

### Embodiment 1.1: DL/Joint TCI State Allocation Based on RRC Configuration

The indicated first DL/Joint TCI state and/or second DL/Joint TCI state is allocated based on a grouping manner of the RRC signalling on the CORESET group/Search Space Set Group.

The indicated first DL/Joint TCI state and/or second DL/Joint TCI state is followed based on a labeling manner of the RRC signalling on the CORESET/Search Space Set.

The following two solutions are included.

### Solution 1: RRC Configuration Solution Based on CORESET

Unlike an M-DCI mTRP operation, all of the PDCCH repetition, sTRP PDCCH, and SFN PDCCH will not be configured by the NW with the RRC parameter CORESETPoolIndex, and thus there is no way to implicitly identify a TRP. The advantage of such operation is that the NW may send a PDCCH from any TRP, but the UE has no way to know which TRP sent the PDCCH. The UE performs reception only according to the indicated TCI state of the PDCCH.

In an mTRP operation, the NW indicates one, two or more DL/Joint TCI states, and each TCI state corresponds to a TRP. In an operation mode of CJT (Coherent Joint Transmission), up to four TRPs may be supported to perform joint coherent transmission together for the UE. Therefore, it is necessary for the NW to inform the UE how the one or more indicated DL/Joint TCI states correspond to the TRPs, such that the UE may receive and/or send corresponding uplink and downlink channels by the one or more indicated DL/Joint TCI states.

The embodiments of the disclosure consider adopting a manner of RRC signalling for pre-configuration. That is, before the unified TCI state is indicated, the UE is informed that resources of which control channels belong to which TRP. In this way, the UE may correspond the beam of the control channel to the corresponding TRP after receiving the indicated unified TCI state subsequently.

Here, in a scenario of S-DCI multi-TRP operation, the NW may classify all of the multiple CORESETs that may be occupied by the PDCCH into 2 CORESET groups, which may be identified as a first CORESET group and a second CORESET group. If a CORESET is not explicitly grouped, it may be considered to belong to the first CORESET group by default. In this way, the CORESET groups exactly correspond one-by-one to the indicated first DL/Joint TCI state and second DL/Joint TCI state as defined. It is to be noted that in previous protocols, the transmission beam corresponding to the PDCCH is configured and activated in units of CORESETs.

As another processing manner for the CORESET, instead of directly grouping the CORESETs, each CORESET is identified by the RRC signalling, as it should follow the one or more indicated DL/Joint TCI states. For example, a CORESET may be configured to follow one of the following.
The first DL/Joint TCI state;
the second DL/Joint TCI state;
the first and second DL/Joint TCI state; or.
the NW may configure the CORESET not to follow any indicated unified TCI state.

For the last case (i.e. the CORESET does not follow any indicated unified TCI state), there is indeed a special case in Rel. 17. If a reference signal included in the unified TCI state is an SSB from a non-serving cell or a neighboring cell, a UE non-exclusive control channel may only use the downlink reference signal of the serving cell as the DL/Joint TCI state. Therefore, the last case means that the CORESET may not follow the unified TCI state as defined in Rel.17, but rather follow the TCI state indicated by the signalling manner defined in Rel.15/16.

For sTRP PDCCH and PDCCH repetition transmission manners, each CORESET may only have one transmitted beam. Therefore, RRC configuration of the CORESET in which these PDCCHs are located may only follow the first or the second DL/Joint TCI state, or simply not to follow the indicated TCI state. However, for the PDCCH SFN transmission solution, the CORESET is sent by different TRPs by different beams on the same time-frequency resource, and a CORESET is required to be activated with two different downlink transmission beams. Therefore, for the CORESET of the SFN PDCCH, the NW should use the RRC signalling to indicate it to follow the first DL/Joint TCI state and the second DL/Joint TCI state.

In an example, information included in the resource configuration information of the CORESET is as follows.

| | |
|---|---|
| ControlResourceSet ::= | SEQUENCE { |
| controlResourceSetId | ControlResourceSetId, |
| frequencyDomainResources | BIT STRING (SIZE (45)), |
| duration | INTEGER (1..maxCoReSetDuration), |
| cce-REG-MappingType | CHOICE { |
| interleaved | SEQUENCE { |
| reg-BundleSize | ENUMERATED {n2, n3, n6}, |
| interleaverSize | ENUMERATED {n2, n3, n6}, |
| shiftIndex | INTEGER(0..maxNrofPhysicalResourceBlocks-1) |

OPTIONAL
},

| | |
|---|---|
| nonInterleaved | NULL |

},

| | |
|---|---|
| precoderGranularity | ENUMERATED {sameAsREG-bundle, |

allContiguousRBs},

| | |
|---|---|
| tci-StatesPDCCH-ToAddList | SEQUENCE(SIZE (1..maxNrofTCI-StatesPDCCH)) |

OF TCI-StateId OPTIONAL, -- Cond NotSIB1-initialBWP

| | |
|---|---|
| tci-StatesPDCCH-ToReleaseList | SEQUENCE(SIZE (1..maxNrofTCI- |

StatesPDCCH)) OF TCI-StateId OPTIONAL, -- Cond NotSIB1-initialBWP

| | |
|---|---|
| tci-PresentInDCI | ENUMERATED {enabled} OPTIONAL, |
| pdcch-DMRS-ScramblingID | INTEGER (0..65535) OPTIONAL, |

```
    ...,
    [[
```

| | |
|---|---|
| rb-Offset-r16 | INTEGER (0..5) OPTIONAL, |
| tci-PresentDCI-1-2-r16 | INTEGER (1..3) OPTIONAL, |
| coresetPoolIndex-r16 | INTEGER (0..1) OPTIONAL, |
| controlResourceSetId-v1610 | ControlResourceSetId-v1610 OPTIONAL |

```
    ]],
    [[
```

| | |
|---|---|
| followUnifiedTCIstate-r17 | ENUMERATED {enabled} OPTIONAL |

]]

| | |
|---|---|
| coresetGroupID | INTEGER (0..1) OPTIONAL, |
| followIndicatedTCIstate | ENUMERATED {1stIndicatedTCI, |
| 2ndIndicatedTCI, 1stAnd2ndIndicatedTCIstate, none} | OPTIONAL |

}

Here, coresetGroupID indicates the CORESET group to which the CORESET belongs, and followIndicatedTCIstate indicates the unified TCI state associated with or followed by the CORESET.

As shown in FIG. 9, the transmission resource of TRP1 is the first transmission resource, and the first transmission resource may include CORESET1 or SSS1. The first transmission resource belongs to the first transmission resource group, and the first transmission resource group follows the first indicated unified TCI state. The transmission resource of TRP2 is the second transmission resource, and the second transmission resource may include CORESET2 or SSS2. The second transmission resource belongs to the second transmission resource group, and the second transmission resource group follows the second indicated unified TCI state. In the PDCCH repetition transmission mode, the first transmission resource is used for TRP1 and the second transmission resource is used for TRP2. TRP1 transmits the data stream on the first transmission resource by the first indicated unified TCI state, and TRP2 transmits the data stream on the second transmission resource by the second indicated unified TCI state. In the PDCCH SFN mode, the first transmission resource is used for TRP1 and TRP2, or the second transmission resource is used for TRP1 and TRP2. TRP1 uses the first indicated unified TCI state and TRP2 uses the second indicated unified TCI state to transmit the data stream on the first transmission resource or the second transmission resource simultaneously.

### Solution 2: RRC Configuration Solution Based on Search Space Set

In the embodiments of the disclosure, multiple Search Space Sets associated with multiple CORESETs that may be occupied by the PDCCH may further be configured by the RRC signalling.

The multiple Search Space Sets may be identified as a first Search Space Set group and a second Search Space Set group. The first Search Space Set group and the second Search Space Set group correspond one-to-one to the indicated first DL/Joint TCI state and second DL/Joint TCI state.

The Search Space Set may also be configured to follow one or more indicated DL/Joint TCI states. For example, the Search Space Set may be configured to follow the first DL/Joint TCI state, the second DL/Joint TCI state, the first and second DL/Joint TCI states, or not to follow the indicated unified TCI state.

In the embodiments of the disclosure, the correspondence between the Search Space Set and the CORESET is an one-to-one mapping. When the correspondence between the Search Space Set and the CORESET is a many-to-one mapping, i.e., multiple Search Space Sets may be associated with the same CORESET, up to 3 CORESETs and up to 10 Search Space Sets may be configured on an activated BWP. Therefore, the NW should be careful enough when configuring the association relationship between the Search Space Set and the CORESET. If two Search Space Sets are associated with the same CORESET and beams followed by the two Search Space Sets are inconsistent (one SSS follows the first DL/Joint TCI state and the other SSS follows the second DL/Joint TCI state), the UE will be unnecessarily confused at reception.

In an example, information included in the resource configuration information of the SSS is as follows.

| | |
|---|---|
| SearchSpace ::= | SEQUENCE { |
| searchSpaceId | SearchSpaceId, |
| controlResourceSetId | ControlResourceSetId OPTIONAL, -- Cond SetupOnly |
| searchSpaceSetGroupID | INTEGER (0..1) OPTIONAL, -- Need S |
| followIndicatedTCIstate | ENUMERATED {1 stIndicatedTCI, |
| 2ndIndicatedTCI, 1stAnd2ndIndicatedTCIstate, none} | OPTIONAL -- Need R |
| monitoringSlotPeriodicityAndOffset | CHOICE { |
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639), |
| sl1280 | INTEGER (0..1279), |
| sl2560 | INTEGER (0..2559) |

} OPTIONAL, -- Cond Setup4

| | |
|---|---|
| duration | INTEGER (2..2559) OPTIONAL, |
| monitoringSymbolsWithinSlot | BIT STRING (SIZE (14)) OPTIONAL, |
| nrofCandidates | SEQUENCE { |
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |

} OPTIONAL, -- Cond Setup

| | |
|---|---|
| searchSpaceType | CHOICE { |
| common | SEQUENCE { |
| dci-Format0-0-AndFormat1-0 | SEQUENCE { |

```
          ...
        } OPTIONAL, -- Need R
```

| | |
|---|---|
| dci-Format2-0 | SEQUENCE { |
| nrofCandidates-SFI | SEQUENCE { |
| aggregationLevel1 | ENUMERATED {n1, n2} OPTIONAL, |
| aggregationLevel2 | ENUMERATED {n1, n2} OPTIONAL, |
| aggregationLevel4 | ENUMERATED {n1, n2} OPTIONAL, |
| aggregationLevel8 | ENUMERATED {n1, n2} OPTIONAL, |
| aggregationLevel16 | ENUMERATED {n1, n2} OPTIONAL |

```
          },
          ...
        } OPTIONAL,
```

| | |
|---|---|
| dci-Format2-1 | SEQUENCE { |

```
          ...
        } OPTIONAL,
```

| | |
|---|---|
| dci-Format2-2 | SEQUENCE { |

```
          ...
        } OPTIONAL,
```

| | |
|---|---|
| dci-Format2-3 | SEQUENCE { |
| dummy1 | ENUMERATED {sl1, sl2, sl4, sl5, sl8, sl10, sl16, |

sl20} OPTIONAL,

| | |
|---|---|
| dummy2 | ENUMERATED {n1, n2}, |

```
          ...
        } OPTIONAL
      },
```

| | |
|---|---|
| ue-Specific | SEQUENCE { |
| dci-Formats | ENUMERATED {formats0-0-And-1-0, formats0-1-And-1- |

```
1},
        ...,
        [[
```

| | |
|---|---|
| dci-Formats-MT-r16 | ENUMERATED {formats2-5} OPTIONAL, |
| dci-FormatsSL-r16 | ENUMERATED {formats0-0-And-1-0, formats0-1- |
| And-1-1, formats3-0, formats3-1, formats3-0-And-3-1} | OPTIONAL, |
| dci-FormatsExt-r16 | ENUMERATED {formats0-2-And-1-2, formats0-1- |
| And-1-1And-0-2-And-1-2} | OPTIONAL |

```
        ]]
      }
```

| | |
|---|---|
| } | OPTIONAL -- Cond Setup2 |

}

Here, controlResourceSetId indicates the CORESET corresponding to the SSS, searchSpaceSetGroupID indicates the SSS group associated with the SSS, and followIndicatedTCIstate indicates the unified TCI state associated with or followed by the SSS.

Considering different PDCCH transmission solutions, for sTRP PDCCH and PDCCH repetition transmission manners, each CORESET may only have one transmitted beam. Then, the RRC configuration of the Search Space Set associated with the CORESET may only follow the first or the second DL/Joint TCI state, or simply not to follow the indicated TCI state. But for the PDCCH SFN transmission solution, the CORESET is sent by different TRPs by different beams on the same time-frequency resource, and the Search Space Set associated with the CORESET is required to be activated with two different downlink transmission beams. Therefore, the NW should use the RRC signalling to indicate it to follow the first DL/Joint TCI state and the second DL/Joint TCI state.

### Embodiment 1.2: DL/Joint TCI State Indication Based on a Fixed Manner of Configuration

The first DL/Joint TCI state and/or the second DL/Joint TCI state, which the CORESET/Search Space Set applies to, are grouped based on a fixed manner.

In the embodiments of the disclosure, it is also possible to consider the fixed manner in the protocol to allocate the indicated one or more DL/Joint TCI states to the PDCCH, which, similarly, may be divided into two manners, i.e., the CORESET and the Search Space Set.

It is assumed that the MAC CE or MAC CE+DCI indicates two DL/Joint TCI states. If the PDCCH is in the sTRP PDCCH or PDCCH repetition transmission manner (the CORESET/Search Space Set only needs one activated TCI state), the CORESET/Search Space Set follows the first indicated DL/Joint TCI state by default. Of course, it is also possible to follow the second indicated DL/Joint TCI state by default, which is only a rule without any technical difference. If the PDCCH is in the SFN PDCCH transmission manner (the CORESET/Search Space Set needs two activated TCI states), the CORESET/Search Space Set follows the first and second indicated DL/Joint TCI states by default.

It is assumed that the MAC CE or MAC CE+DCI indicates only 1 DL/Joint TCI state. If the PDCCH is in the sTRP PDCCH or PDCCH repetition transmission manner (the CORESET/Search Space Set only needs one activated TCI state), the CORESET/Search Space Set follows the indicated DL/Joint TCI state by default (there is no need to distinguish between the first or second DL/Joint TCI state here). If the PDCCH is in the SFN PDCCH transmission manner (the CORESET/Search Space Set needs two activated TCI states), the SFN PDCCH can not be performed in such case. The UE may understand such case as an Error Case of the NW indication, which is not expected by the UE to happen.

### Embodiment 1.3: DL/Joint TCI State Allocation Based on MAC CE Activation

Configuration based on the RRC signalling is a relatively static solution. In the embodiments of the disclosure, a more flexible MAC CE may be used, with the premise that corresponding adjustment is performed by the MAC CE based on the RRC signalling configuration. In the following, two designs with MAC CE are introduced, which correspond exactly to the two mechanisms of RRC configuration.

In a first design, the indicated first DL/Joint TCI state and/or second DL/Joint TCI state is allocated based on a grouping manner of the MAC CE signalling on the CORESET group/Search Space Set Group.

In the first design, the MAC CE should at least include the following information.
Serving cell identification (ID)
BWP ID
CORESET Group ID/SSS Group ID (Search Space Set Group ID)
Indicate to follow
   1^{st} DL/Joint TCI state or
   2^{nd} DL/Joint TCI state or
   First Downlink/Joint TCI state and second uplink/Joint TCI state (Both DL/Joint TCI states) or
   None

Here, none may be understood as a reserved state, i.e., the first downlink/joint TCI state or the second uplink/joint TCI state is not followed.

From the above information in the MAC CE, the UE may decipher that a CORESET group or a Search Space Set group on a CC/BWP follows the indicated first DL/Joint TCI state, the second DL/Joint TCI state, the first DL/Joint TCI state and the second DL/Joint TCI state (both DL/Joint TCI states), or does not follow any unified TCI state.

In a second design, the indicated first DL/Joint TCI state and/or second DL/Joint TCI state is followed based on a labeling manner of the MAC CE signalling on the CORESET/Search Space Set.

The difference from the MAC CE in the first design is that the control accuracy is changed from the CORESET group/Search Space Set group to the CORESET/Search Space Set. Formally, the MAC CE should include at least the following information.
Serving cell ID
BWP ID
CORESET ID/Search Space Set ID
Indicate to follow
   1^{st} DL/Joint TCI state or
   2^{nd} DL/Joint TCI state or
   Both DL/Joint TCI states or
   None

### Embodiment 1.4: Allocation of One or More DL/Joint TCI States Based on DCI

### Allocation Manner of Unified TCI States of the CORESET/Search Space Set Based on a DCI Dynamic Signalling

It is considered to introduce a new domain in the uplink and downlink scheduling DCI (e.g., DCI formats 1_1 and 1_2 for downlink scheduling) to indicate which indicated DL/Joint TCI state is followed by the CORESET, CORESET Group, Search Space Set or Search Space Set Group in which the PDCCH is located.

Of course, here, it is further possible to consider to extend the function, i.e., the data channel PDSCH/PUSCH, the control channel PUCCH, and the reference signals, such as the non-periodic CSI-RS and the non-periodic SRS, or the like, which are scheduled by the PDCCH, also follow the same unified TCI state as the PDCCH.

The new domain may be named as FollowIndicatedTCIStatePDCCH. The design of codepoints and the corresponding behavior of the UE may be referred to Table 1. The domain indicates the TRP from which the UE should receive the PDCCH.

TABLE 1
Relationship between design of codepoints
and UE's corresponding behavior

| FollowIndicatedTCIStatePDCCH | UE's behavior |
|---|---|
| 00 | following the first indicated |
| | DL/UL/Joint TCI state |
| 01 | following the second indicated |
| | DL/UL/Joint TCI state |
| 10 | following the first indicated |
| | DL/UL/Joint TCI state and the |
| | second indicated DL/UL/Joint |
| | TCI state tate |
| 11 | reserved |

### Embodiment 2: Indication/Update for One or More Unified TCI States of the PDSCH

### Embodiment 2.1: A Following Solution of the First DL/Joint TCI State and/or the Second DL/Joint TCI State

For a PDSCH scheduled by the PDCCH, the simplest strategy for the PDSCH to use the DL/Joint TCI state is to follow the DL/Joint TCI state used by the PDCCH that schedules it. That is, for the same downlink transmitted TRP, the UE receives the PDCCH and the PDSCH by the same downlink receiving beam.

### Embodiment 2.2

Considering combinations of different transmission manners of the PDCCH and the transmission manner of the PDSCH, and one or more indicated unified TCI states used by the PDCCH, the solution for one or more indicated unified TCI states used by the PDSCH includes the following.

It is assumed that the MAC CE or MAC CE+DCI indicates only 2 DL/Joint TCI states.
If the PDSCH is transmission from mTRP (whether dynamically indicated by the DCI or configured by the NW in advance, e.g., semi-static PDSCH), the UE receives the PDSCH by the indicated first and second DL/Joint TCI states regardless of the transmission manner of the scheduling DCI (sTRP or mTRP).
If the PDSCH is transmission from sTRP, it is necessary to take into account the beam used by the CORESET or Search Space Set in which the scheduling DCI is located, i.e., whether the first DL/Joint TCI state or the second DL/Joint TCI state. The UE receives the PDSCH by the same indicated DL/Joint TCI state as the PDCCH. Of course, the premise here is that the CORESET/Search Space Set uses the unified TCI state, instead of the TCI state defined in Rel. 15/16.

It is assumed that the MAC CE or MAC CE+DCI indicates only 1 DL/Joint TCI state.
If the PDSCH is configured as transmission from mTRP, regardless of the transmission manner of the scheduling DCI (sTRP or mTRP), the UE may understand that such self-contradictory indication from the NW is an error case, and the UE does not expect to receive such indication.
If the PDSCH is scheduled to indicate transmission from sTRP, it is enough for the UE to receive the PDSCH by the first or second DL/Joint TCI state indicated by the NW.

### Embodiment 3: Indication/Update for One or More Unified TCI States of the PUSCH

An Indication Solution of the Association Relationship Between the First and/or Second SRS Resource Set and the First and/or Second UL/Joint TCI State and the Uplink Beam Based on the RRC Signalling

In Rel.17, repetition transmission of the PUSCH mTRP in the time domain is supported, and the beam direction follows the beam direction of the SRS resource indicated by the uplink scheduling DCI in the first and/or second SRS Resource Set. As mentioned above, when the unified TCI state is configured and indicated by the NW, the UE is indicated by the NW with the first and/or second UL/Joint TCI state.

### Embodiment 3.1: Association of the SRS Resource Set and the UL/Joint TCI State Based on the RRC Signalling

We design a high-level RRC signalling to associate (based on the purpose of codebook or non-codebook) the SRS resource set and one or more unified TCI states indicated by the NW, to perform TDM-based PUSCH repetition transmission. Specifically, the RRC signalling may configure the first SRS resource set to be associated with the first indicated UL/Joint TCI state, and the second SRS resource set to be associated with the first indicated UL/Joint TCI state. Of course, such configuration relationship may also be crossed when configured, for example, the first SRS resource set is associated with the second indicated UL/Joint TCI state.

In this way, when receiving an existing uplink mTRP PUSCH transmission scheduling, the UE may select to send a TDM-based PUSCH on different transmission occasions in the time domain according to the manner in the existing protocols. For example, on the first PUSCH transmission occasion, the UE sends the first PUSCH occasion in the time domain towards TRP #1 (SRS resource set #1 is associated with the first UL/Joint TCI state). On the second PUSCH transmission occasion, the UE sends the second PUSCH occasion in the time domain towards TRP #2 (SRS resource set #2 is associated with the second UL/Joint TCI state).

If only one SRS resource set is provided in the UL DCI when the UE receives an uplink sTRP PUSCH transmission scheduling, the UE may also find the first or second UL/Joint TCI state associated with the SRS resource set for transmission.

### Embodiment 3.2: Association of the PUSCH Transmission Occasion and the UL/Joint TCI State Based on the RRC Signalling

In addition to the aforementioned solution of associating the SRS resource set with the indicated unified TCI state, we may further think of directly associating the transmission occasion of the PUSCH repetition transmission with the indicated first and second UL/Joint TCI states. The term “transmission occasion” may be understood as an opportunity that transmission occurs in the time domain, which generally occurs only when uplink transmission resources are scheduled by the NW or preconfigured.

Specifically, the first PUSCH transmission occasion is associated with the first UL/Joint TCI state indicated by the NW, and the second PUSCH transmission occasion is associated with the second UL/Joint TCI state indicated by the NW. When the number of times of PUSCH repetition transmission is greater than 2, for example, 4 or 8 repetitions, such manner may be extended as a minimum unit. A third PUSCH transmission occasion is associated with the first UL/Joint TCI state indicated by the NW, a fourth PUSCH transmission occasion is associated with the second UL/Joint TCI state indicated by the NW, and so on.

### Embodiment 3.3: Association Relationship Updated Based on the MAC CE

An Indication Solution of the Association Relationship Between the First and/or Second SRS Resource Set and the First and/or Second UL/Joint TCI State and the Uplink Beam Based on the MAC CE Signalling

For the aforementioned association relationship of the RRC signalling (between the SRS resource set and the indicated UL/Joint TCI state), it is a semi-static configuration manner. In order to better increase flexibility of the PUSCH transmission, on the basis of RRC configuration, the embodiments of the disclosure further consider introducing the MAC CE to change such association relationship. For example, the first indicated UL/Joint TCI state associated with the first SRS resource set is changed to the second indicated UL/Joint TCI state.

Then, the MAC CE should include at least the following information.
Serving cell ID
BWP ID
SRS resource set ID
Indicate to follow
   1^{st} UL/Joint TCI state or
   2^{nd} UL/Joint TCI state or
   None

### Embodiment 4: Indication/Update for One or More Unified TCI States of the PUCCH

A transmission solution that the PUCCH TDM repetition is oriented 2 TRPs is introduced in Rel. 17. Each PUCCH resource may be activated by the MAC CE with 1 or 2 uplink transmission beams, i.e. Spatial Relation Information.

### Embodiment 4.1: Indication Solution of the UL/Joint TCI State of all PUCCH Resources

a Solution that all PUCCH Resources Follow the Indicated First and/or Second UL/Joint TCI State

In Rel.18, it is necessary to enhance the PUCCH transmission solution based on UL/Joint TCI state, which may actually be achieved with a very simple implementation, i.e., 1 or 2 UL/Joint TCI states indicated in the MAC CE or MAC CE+DCI are used by all PUCCH resources. If 1 UL/Joint TCI state is indicated, the UE performs sTRP transmission of all PUCCH resources on the CC/BWP to which the indicated unified TCI state applies, regardless of whether the PUCCH resource is used to carry HARQ, Channel State Information (CSI), or SR. If 2 UL/Joint TCI states are indicated, the UE performs mTRP transmission of all PUCCH resources on the CC/BWP to which the indicated unified TCI state applies.

The PUCCH transmission solution may be performed simultaneously (e.g. SDM or FDM), or may be time-shared (e.g. TDM) PUCCH repetition.

The PUCCH transmission solution may be performed simultaneously (e.g. SDM or FDM), or may be time-shared (e.g. TDM) PUCCH repetition.

### Embodiment 4.2: Indication Solution of the UL/Joint TCI State Based on the PUCCH Resource Group

A Solution that the PUCCH Resource Group Follows the Indicated First and/or Second UL/Joint TCI State

In addition to the aforementioned solution that all PUCCH resources use a set of first and/or second UL/Joint TCI states, there is a more flexible manner that the NW divides the PUCCH resources into several groups by the RRC signalling, i.e., the PUCCH resource group. For example, a PUCCH resource group may include up to 64 PUCCH resources, and there may be up to 4 PUCCH resource groups.

On the basis of such design, the NW may indicate up to 4 groups of first and/or second UL/Joint TCI states to respectively correspond one-to-one to 4 PUCCH resource groups. The correspondences here may be configured by the NW through the RRC signalling.

In an example, the PUCCH resource group and the unified TCI state may be set through the following information.

| | |
|---|---|
| PUCCH-ResourceGroup-r16 ::= | SEQUENCE { |
| pucch-ResourceGroupId-r16 | PUCCH-ResourceGroupId-r16, |
| resourcePerGroupList-r16 | SEQUENCE (SIZE (1..maxNrofPUCCH- |

ResourcesPerGroup-r16)) OF PUCCH-ResourceId

| | |
|---|---|
| followIndicatedTCIstate | ENUMERATED {1stIndicatedTCI, |
| 2ndIndicatedTCI, 1stAnd2ndIndicatedTCIstate, none} | OPTIONAL -- Need R |

pucch-ResourceGroupId-r16 indicates the PUCCH resource group, and followIndicatedTCIstate indicates the unified TCI state associated with or followed by the PUCCH resource group.

Furthermore, it may also be a feasible solution to update/indicate through the MAC CE signalling on the basis of the RRC signalling configuration. In an example, the MAC CE may at least include the following information.
Serving cell ID
BWP ID.
PUCCH resource ID/PUCCH resource group ID
Indicate to follow
   1^{st} UL/Joint TCI state or
   2^{nd} UL/Joint TCI state or
   Both UL/Joint TCI states or
   None

It is to be noted that if the third item indicated in the MAC CE is the PUCCH resource ID, each of all PUCCH resources in the PUCCH resource group, in which the PUCCH resource is located, will update the followed unified TCI state.

In this way, each group of PUCCH resources may perform sTRP transmission (the first or second UL/Joint TCI state) or mTRP transmission (the first and second UL/Joint TCI states).

The embodiments of the disclosure provide a wireless communication method. when the UE is configured and indicated with one or more unified TCI states and the UE operates in the mTRP scenario, how each of different uplink and downlink channels uses the indicated unified TCI state.

The preferred implementations of the disclosure are described in detail above in combination with the drawings, but the disclosure is not limited to the specific details in the aforementioned implementations. Within the scope of the technical conception of the disclosure, a variety of simple variations of the technical solutions of the disclosure may be performed, and all of these simple variations fall within the scope of protection of the disclosure. For example, various specific technical features described in the above specific implementations may be combined in any suitable manner without contradiction, and in order to avoid unnecessary repetition, various possible combinations are not separately illustrated in the disclosure. Further, for example, various different implementations of the disclosure may also be arbitrarily combined, and as long as they do not contradict the idea of the disclosure, they should be regarded as the contents disclosed in the disclosure. Further, for example, on the premise of no conflict, the various embodiments and/or technical features in the various embodiments described in the disclosure may be arbitrarily combined with the related art, and the technical solutions obtained after the combination shall also fall within the scope of protection of the disclosure.

It is further to be understood that in various method embodiments of the disclosure, the magnitude of the serial numbers of the aforementioned processes does not imply the order of execution. The order of execution of the processes shall be determined by their functions and internal logic, and shall not constitute any limitation on the implementation process of the embodiments of the disclosure. Furthermore, in the embodiments of the disclosure, the terms “downlink”, “uplink” and “sidelink” are used to represent a transmission direction of signals or data. “Downlink” is used to represent that the transmission direction of signals or data is a first direction from the site to the user device of the cell, “uplink” is used to represent that the transmission direction of signals or data is a second direction from the user device of the cell to the site, and “sidelink” is used to represent that the transmission direction of signals or data is a third direction from user device 1 to user device 2. For example, a “downlink signal” represents that the signal is transmitted in the first direction. In addition, in the embodiments of the disclosure, the term “and/or” is only a description of an association relationship of associated objects, representing that there may be three kinds of relationships. Specifically, “A and/or B” may represent three conditions, i.e., independent existence of A, existence of both A and B, and independent existence of B. In addition, the character “/” herein usually represents that the previous and next associated objects are in an “or” relationship.

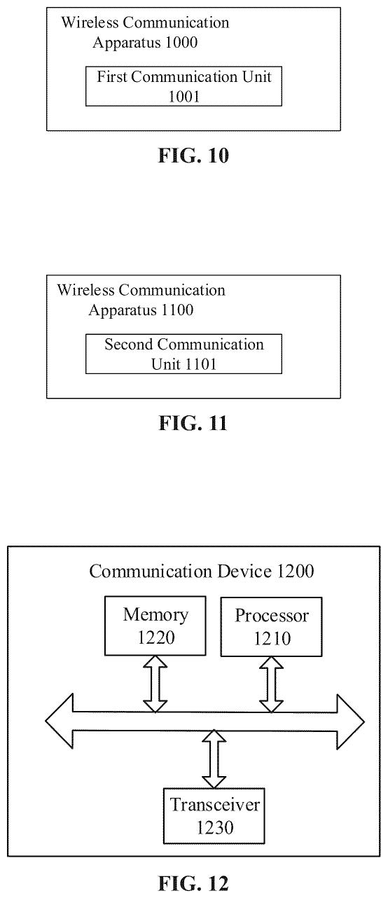

FIG. 10 is a schematic diagram of a structure of a wireless communication apparatus provided by an embodiment of the disclosure, and the apparatus is applied to a terminal device. As shown in FIG. 10, the wireless communication apparatus 1000 includes a first communication unit 1001.

The first communication unit 10001 is configured to receive a first unified TCI state and/or a second unified TCI state sent from a network device. The first unified TCI state is used for a first uplink channel/signal and/or a first downlink channel/signal, and the second unified TCI state is used for a second uplink channel/signal and/or a second downlink channel/signal. The first uplink channel/signal and the second uplink channel/signal have different receiving ends and the same transmitting end, and the first downlink channel/signal and the second downlink channel/signal have different transmitting ends and the same receiving end.

In some embodiments, the first unified TCI state is associated with a first transmission resource or a first transmission resource group to which the first transmission resource belongs, and the second unified TCI state is associated with a second transmission resource or a second transmission resource group to which the second transmission resource belongs. The first transmission resource is a transmission resource associated with the first uplink channel/signal or the first downlink channel/signal, and the second transmission resource is a transmission resource associated with the second uplink channel/signal or the second downlink channel/signal.

In some embodiments, the first transmission resource is the same as or different from the second transmission resource.

In some embodiments, the transmission resource includes at least one of a PDCCH resource, a CORESET, an SSS, a PDSCH resource, a PUSCH resource, an SRS resource, a transmission occasion, a PUCCH resource, or a CSI-RS resource.

In some embodiments, a configuration manner of a first association relationship between the first unified TCI state and the first transmission resource and a second association relationship between the second unified TCI state and the second transmission resource includes at least one of:
being configured by the network device; or
being configured by the terminal device.

In some embodiments, the first association relationship is configured by first information sent from the network device, and the second association relationship is configured by second information sent from the network device. The first information includes first configuration information for the first transmission resource or the first transmission resource group. The second information includes second configuration information for the second transmission resource or the second transmission resource group. The first configuration information includes the first unified TCI state, and the second configuration information includes the second unified TCI state.

In some embodiments, the first information and/or the second information is transmitted through a first signalling. The first signalling includes at least one of:
an RRC signalling;
an MAC CE; or
DCI.

In some embodiments, a first association relationship indicated by the first information transmitted through the MAC CE and/or a second association relationship indicated by the second information transmitted through the MAC CE is used to update an existing first association relationship and/or an existing second association relationship.

In some embodiments, the MAC CE includes at least one of first indicative information, second indicative information, third indicative information or fourth indicative information.

The first indicative information is configured to indicate a serving cell.

The second indicative information is configured to indicate a BWP.

The third indicative information is configured to indicate a target transmission resource or a target transmission resource group. The target transmission resource is the first transmission resource or the second transmission resource, and the target transmission resource group is the first transmission resource group or the second transmission resource group.

The fourth indicative information is configured to indicate a target unified TCI state associated with the target transmission resource or the target transmission resource group.

In some embodiments, the DCI includes a first domain of the target transmission resource or the target transmission resource group. The first domain includes fifth indicative information, and the fifth indicative information is configured to indicate the target unified TCI state associated with the target transmission resource or the target transmission resource group.

In some embodiments, the target unified TCI state includes one of:
the first unified TCI state;
the second unified TCI state;
the first unified TCI state and the second unified TCI state; or
a reserved state.

In some embodiments, if the target transmission resource belongs to a downlink transmission resource or the target transmission resource group belongs to a downlink transmission resource group, and the target unified TCI state is the reserved state, the target transmission resource or the target transmission resource group is associated with a TCI state.

In some embodiments, if the first downlink channel is a first PDCCH and the second downlink channel is a second PDCCH, a first CORESET, which is associated with the first PDCCH, is associated with the first unified TCI state, and a second CORESET, which is associated with the second PDCCH, is associated with the second unified TCI state.

In some embodiments, if the first downlink channel is the first PDCCH and the second downlink channel is the second PDCCH, a first CORESET group, which is associated with the first PDCCH, is associated with the first unified TCI state, and a second CORESET group, which is associated with the second PDCCH, is associated with the second unified TCI state.

In some embodiments, the first CORESET group includes at least one CORESET that can be occupied by the first PDCCH, and the second CORESET group includes at least one CORESET that can be occupied by the second PDCCH.

In some embodiments, if the first downlink channel is the first PDCCH and the second downlink channel is the second PDCCH, a first SSS is associated with the first unified TCI state, and a second SSS is associated with the second unified TCI state. The first SSS is associated with the first CORESET which is associated with the first PDCCH, and the second SSS is associated with the second CORESET which is associated with the second PDCCH.

In some embodiments, if the first downlink channel is the first PDCCH and the second downlink channel is the second PDCCH, a first SSS group is associated with the first unified TCI state, and a second SSS group is associated with the second unified TCI state. The first SSS group is associated with the first CORESET group which is associated with the first PDCCH, and the second SSS group is associated with the second CORESET group which is associated with the second PDCCH.

In some embodiments, the first SSS group includes each SSS associated with a respective COREST in the first CORESET group, and the second SSS group includes each SSS associated with a respective COREST in the second CORESET group.

In some embodiments, a first channel and/or a first signal scheduled by the first PDCCH is associated with the first unified TCI state, and a second channel and/or a second signal scheduled by the second PDCCH is associated with the second unified TCI state.

In some embodiments, the first channel includes a first PDSCH and the second channel includes a second PDSCH; and/or
the first channel includes a first PUSCH and the second channel includes a second PUSCH; and/or
the first channel includes a first PUCCH and the second channel includes a second PUCCH.

In some embodiments, the first signal includes a CSI-RS and the second signal includes a second CSI-RS; and/or
the first signal includes a first SRS and the second signal includes a second SRS.

In some embodiments, the first downlink channel is the first PDSCH and the second downlink channel is the second PDSCH. The first PDSCH is associated with the first COREST, and the second PDSCH is associated with the first COREST. The first COREST is associated with the first unified TCI state and the second unified TCI state.

In some embodiments, the first unified TCI state and the second unified TCI state are associated with all CORESTs used by the terminal device to transmit a PDSCH.

In some embodiments, the first uplink channel is the first PUSCH and the second uplink channel is the second PUSCH. A first SRS resource set, which is associated with the first PUSCH, is associated with the first unified TCI state, and a second SRS resource set, which is associated with the second PUSCH, is associated with the second unified TCI state.

In some embodiments, the first uplink channel is the first PUSCH and the second uplink channel is the second PUSCH. A first transmission opportunity, which is associated with the first PUSCH, is associated with the first unified TCI state, and a second transmission opportunity, which is associated with the second PUSCH, is associated with the second unified TCI state.

In some embodiments, the first uplink channel is the first PUCCH and the second uplink channel is the second PUCCH. A first PUCCH resource group, in which a first PUCCH resource associated with the first PUCCH is located, is associated with the first unified TCI state. A second PUCCH resource group, in which a second PUCCH resource associated with the second PUCCH is located, is associated with the second unified TCI state.

In some embodiments, the first PUCCH resource being associated with the first unified TCI state is used to determine that the first PUCCH resource group is associated with the first unified TCI state. The second PUCCH resource being associated with the second unified TCI state is used to determine that the second PUCCH resource group is associated with the second unified TCI state.

In some embodiments, the first unified TCI state and the second unified TCI state are associated with all PUCCH resources on a first CC or a first BWP. The first CC or the first BWP is a CC or a BWP applicable to the first unified TCI state and the second unified TCI state.

In some embodiments, the first unified TCI state includes a first joint TCI state, and the second unified TCI state includes a second joint TCI state. The first joint TCI state is used for the first downlink channel/signal and the first uplink channel/signal, and the second joint TCI state is used for the second uplink channel/signal and the second downlink channel/signal.

In some embodiments, the first united TCI state includes a first separate uplink TCI state and a first separate downlink TCI state, and the second united TCI state includes a second separate uplink TCI state and a second separate downlink TCI state. The first separate downlink TCI state is used for the first downlink channel/signal, and the first separate uplink TCI state is used for the first uplink channel/signal. The second separate downlink TCI state is used for the second downlink channel/signal, and the second separate uplink TCI state is used for the second uplink channel/signal.

In some embodiments, the first communication unit 1001 is further configured to:
receive a third unified TCI state sent from the network device. The third unified TCI state is used for the first uplink channel/signal and/or the first downlink channel/signal, or the third unified TCI state is used for the second uplink channel/signal and/or the second downlink channel/signal.

FIG. 11 is a schematic diagram of a structure of a wireless communication apparatus provided by an embodiment of the disclosure, and the apparatus is applied to a network device. As shown in FIG. 11, the wireless communication apparatus 1100 includes a second communication unit 1101.

The second communication unit 1101 is configured to send a first unified TCI state and/or a second unified TCI state to a terminal device. The first unified TCI state is used for a first uplink channel/signal and/or a first downlink channel/signal, and the second unified TCI state is used for a second uplink channel/signal and/or a second downlink channel/signal. The first uplink channel/signal and the second uplink channel/signal have different receiving ends and the same transmitting end, and the first downlink channel/signal and the second downlink channel/signal have different transmitting ends and the same receiving end.

In some embodiments, the first unified TCI state is associated with a first transmission resource or a first transmission resource group to which the first transmission resource belongs, and the second unified TCI state is associated with a second transmission resource or a second transmission resource group to which the second transmission resource belongs. The first transmission resource is a transmission resource associated with the first uplink channel/signal or the first downlink channel/signal, and the second transmission resource is a transmission resource associated with the second uplink channel/signal or the second downlink channel/signal.

In some embodiments, the first transmission resource is the same as or different from the second transmission resource.

In some embodiments, the transmission resource includes at least one of a PDCCH resource, a CORESET, an SSS, a PDSCH resource, a PUSCH resource, an SRS resource, a transmission occasion, a PUCCH resource, or a CSI-RS resource.

In some embodiments, a configuration manner of a first association relationship between the first unified TCI state and the first transmission resource and a second association relationship between the second unified TCI state and the second transmission resource includes at least one of:
being configured by the network device; or
being configured by the terminal device.

In some embodiments, the first association relationship is configured by first information sent from the network device, and the second association relationship is configured by second information sent from the network device. The first information includes first configuration information for the first transmission resource or the first transmission resource group. The second information includes second configuration information for the second transmission resource or the second transmission resource group. The first configuration information includes the first unified TCI state, and the second configuration information includes the second unified TCI state.

In some embodiments, the first information and/or the second information is transmitted through a first signalling. The first signalling includes at least one of:
an RRC signalling;
an MAC CE; or
DCI.

In some embodiments, a first association relationship indicated by the first information transmitted through the MAC CE and/or a second association relationship indicated by the second information transmitted through the MAC CE is used to update an existing first association relationship and/or an existing second association relationship.

In some embodiments, the MAC CE includes at least one of first indicative information, second indicative information, third indicative information or fourth indicative information.

The first indicative information is configured to indicate a serving cell.

The second indicative information is configured to indicate a BWP.

The third indicative information is configured to indicate a target transmission resource or a target transmission resource group. The target transmission resource is the first transmission resource or the second transmission resource, and the target transmission resource group is the first transmission resource group or the second transmission resource group.

The fourth indicative information is configured to indicate a target unified TCI state associated with the target transmission resource or the target transmission resource group.

In some embodiments, the DCI includes a first domain of the target transmission resource or the target transmission resource group. The first domain includes fifth indicative information, and the fifth indicative information is configured to indicate the target unified TCI state associated with the target transmission resource or the target transmission resource group.

In some embodiments, the target unified TCI state includes one of:
the first unified TCI state;
the second unified TCI state;
the first unified TCI state and the second unified TCI state; or
a reserved state.

In some embodiments, if the target transmission resource belongs to a downlink transmission resource or the target transmission resource group belongs to a downlink transmission resource group, and the target unified TCI state is the reserved state, the target transmission resource or the target transmission resource group is associated with a TCI state.

In some embodiments, if the first downlink channel is a first PDCCH and the second downlink channel is a second PDCCH, a first CORESET, which is associated with the first PDCCH, is associated with the first unified TCI state, and a second CORESET, which is associated with the second PDCCH, is associated with the second unified TCI state.

In some embodiments, if the first downlink channel is the first PDCCH and the second downlink channel is the second PDCCH, a first CORESET group, which is associated with the first PDCCH, is associated with the first unified TCI state, and a second CORESET group, which is associated with the second PDCCH, is associated with the second unified TCI state.

In some embodiments, the first CORESET group includes at least one CORESET that can be occupied by the first PDCCH, and the second CORESET group includes at least one CORESET that can be occupied by the second PDCCH.

In some embodiments, if the first downlink channel is the first PDCCH and the second downlink channel is the second PDCCH, a first SSS is associated with the first unified TCI state, and a second SSS is associated with the second unified TCI state. The first SSS is associated with the first CORESET which is associated with the first PDCCH, and the second SSS is associated with the second CORESET which is associated with the second PDCCH.

In some embodiments, if the first downlink channel is the first PDCCH and the second downlink channel is the second PDCCH, a first SSS group is associated with the first unified TCI state, and a second SSS group is associated with the second unified TCI state. The first SSS group is associated with the first CORESET group which is associated with the first PDCCH, and the second SSS group is associated with the second CORESET group which is associated with the second PDCCH.

In some embodiments, the first SSS group includes each SSS associated with a respective COREST in the first CORESET group, and the second SSS group includes each SSS associated with a respective COREST in the second CORESET group.

In some embodiments, a first channel and/or a first signal scheduled by the first PDCCH is associated with the first unified TCI state, and a second channel and/or a second signal scheduled by the second PDCCH is associated with the second unified TCI state.

In some embodiments, the first channel includes a first PDSCH and the second channel includes a second PDSCH; and/or
the first channel includes a first PUSCH and the second channel includes a second PUSCH; and/or
the first channel includes a first PUCCH and the second channel includes a second PUCCH.

In some embodiments, the first signal includes a CSI-RS and the second signal includes a second CSI-RS; and/or
the first signal includes a first SRS and the second signal includes a second SRS.

In some embodiments, the first downlink channel is the first PDSCH and the second downlink channel is the second PDSCH. The first PDSCH is associated with the first COREST, and the second PDSCH is associated with the first COREST. The first COREST is associated with the first unified TCI state and the second unified TCI state.

In some embodiments, the first unified TCI state and the second unified TCI state are associated with all CORESTs used by the terminal device to transmit a PDSCH.

In some embodiments, the first uplink channel is the first PUSCH and the second uplink channel is the second PUSCH. A first SRS resource set, which is associated with the first PUSCH, is associated with the first unified TCI state, and a second SRS resource set, which is associated with the second PUSCH, is associated with the second unified TCI state.

In some embodiments, the first uplink channel is the first PUSCH and the second uplink channel is the second PUSCH. A first transmission opportunity, which is associated with the first PUSCH, is associated with the first unified TCI state, and a second transmission opportunity, which is associated with the second PUSCH, is associated with the second unified TCI state.

In some embodiments, the first uplink channel is the first PUCCH and the second uplink channel is the second PUCCH. A first PUCCH resource group, in which a first PUCCH resource associated with the first PUCCH is located, is associated with the first unified TCI state. A second PUCCH resource group, in which a second PUCCH resource associated with the second PUCCH is located, is associated with the second unified TCI state.

In some embodiments, the first PUCCH resource being associated with the first unified TCI state is used to determine that the first PUCCH resource group is associated with the first unified TCI state. The second PUCCH resource being associated with the second unified TCI state is used to determine that the second PUCCH resource group is associated with the second unified TCI state.

In some embodiments, the first unified TCI state and the second unified TCI state are associated with all PUCCH resources on a first CC or a first BWP. The first CC or the first BWP is a CC or a BWP applicable to the first unified TCI state and the second unified TCI state.

In some embodiments, the first unified TCI state includes a first joint TCI state, and the second unified TCI state includes a second joint TCI state. The first joint TCI state is used for the first downlink channel/signal and the first uplink channel/signal, and the second joint TCI state is used for the second uplink channel/signal and the second downlink channel/signal.

In some embodiments, the first united TCI state includes a first separate uplink TCI state and a first separate downlink TCI state, and the second united TCI state includes a second separate uplink TCI state and a second separate downlink TCI state. The first separate downlink TCI state is used for the first downlink channel/signal, and the first separate uplink TCI state is used for the first uplink channel/signal. The second separate downlink TCI state is used for the second downlink channel/signal, and the second separate uplink TCI state is used for the second uplink channel/signal.

In some embodiments, the second communication unit 1101 is further configured to:
send a third unified TCI state to the terminal device. The third unified TCI state is used for the first uplink channel/signal and/or the first downlink channel/signal, or the third unified TCI state is used for the second uplink channel/signal and/or the second downlink channel/signal.

It is to be understood by those skilled in the art that the related description of the aforementioned wireless communication apparatus of the embodiments of the disclosure may be understood with reference to the related description of the wireless communication method of the embodiments of the disclosure.

FIG. 12 is a schematic diagram of a structure of a communication device 1200 provided by an embodiment of the disclosure. The communication device may be a terminal device or a network device. The communication device 1200 shown in FIG. 12 includes a processor 1210. The processor 1210 may call and run a computer program in a memory to implement the methods in the embodiments of the disclosure.

Optionally, as shown in FIG. 12, the communication device 1200 may further include a memory 1220. The processor 1210 may call and run a computer program in the memory 1220 to implement the methods in the embodiments of the disclosure.

The memory 1220 may be a separate component independent of the processor 1210, or may be integrated into the processor 1210.

Optionally, as shown in FIG. 12, the communication device 1200 may further include a transceiver 1230. The processor 1210 may control the transceiver 1230 to communicate with other devices, specifically, to send information or data to other devices, or to receive information or data sent from other devices.

The transceiver 1230 may include a transmitter and a receiver. The transceiver 1230 may further include antennas. The number of antennas may be one or more.

Optionally, the communication device 1200 may specifically be the network device of the embodiments of the disclosure, and the communication device 1200 may implement the corresponding flows implemented by the network device in each method of the embodiments of the disclosure, which is not repeated here for the sake of brevity.

Optionally, the communication device 1200 may specifically be the mobile terminal or terminal device of the embodiments of the disclosure, and the communication device 1200 may implement the corresponding flows implemented by the mobile terminal or terminal device in each method of the embodiments of the disclosure, which is not repeated here for the sake of brevity.

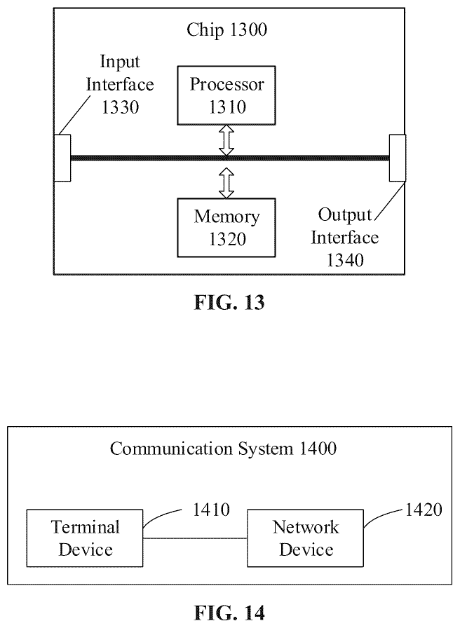

FIG. 13 is a schematic diagram of a structure of a chip of an embodiment of the disclosure. The chip 1300 shown in FIG. 13 includes a processor 1310. The processor 1310 may call and run a computer program in a memory to implement the methods in the embodiments of the disclosure.

Optionally, as shown in FIG. 13, the chip 1300 may further include a memory 1320. The processor 1310 may call and run a computer program in the memory 1320 to implement the methods in the embodiments of the disclosure.

The memory 1320 may be a separate component independent of the processor 1310, or may be integrated into the processor 1310.

Optionally, the chip 1300 may further include an input interface 1330. The processor 1310 may control the input interface 1330 to communicate with other devices or chips, specifically, to obtain information or data sent from other devices or chips.

Optionally, the chip 1300 may further include an output interface 1340. The processor 1310 may control the output interface 1340 to communicate with other devices or chips, specifically, to output information or data to other devices or chips.

Optionally, the chip may be applied to the network device of the embodiments of the disclosure, and the chip may implement corresponding flows implemented by the network device in each method of the embodiments of the disclosure, which is not repeated here for the sake of brevity.

Optionally, the chip may be applied to the mobile terminal or terminal device of the embodiments of the disclosure, and the chip may implement corresponding flows implemented by the mobile terminal or terminal device in each method of the embodiments of the disclosure, which is not repeated here for the sake of brevity.

It is to be understood that the chip referred to in the embodiments of the disclosure may also be referred to as a system-level chip, a system chip, a chip system, a system-on-chip, or the like.

FIG. 14 is a schematic block diagram of a communication system 1400 provided by an embodiment of the disclosure. As shown in FIG. 14, the communication system 1400 includes a terminal device 1410 and a network device 1420.

The terminal device 1410 may be configured to implement corresponding functions implemented by the terminal device in the aforementioned methods, and the network device 1420 may be configured to implement corresponding functions implemented by the network device in the aforementioned methods, which is not repeated here for the sake of brevity.

It is to be understood that the processor in the embodiments of the disclosure may be an integrated circuit chip with a signal processing capability. In an implementation process, various operations in the aforementioned method embodiments may be completed by a hardware integrated logic circuit or instructions in the form of software in the processor. The aforementioned processor may be a general purpose processor, a Digital Signal Processor (DSP), an Application Specific Integrated Circuit (ASIC), a Field Programmable Gate Array (FPGA) or other programmable logic devices, discrete gates or transistor logic devices, or discrete hardware components. Various methods, operations and logic block diagrams disclosed in the embodiments of the disclosure may be implemented or executed. The general purpose processor may be a microprocessor, or the processor may be any conventional processor or the like. Operations in combination with methods disclosed in the embodiments of the disclosure may be directly embodied to be executed and completed by a hardware decoding processor, or by a combination of hardware and software modules in the decoding processor. The software module may be located in a mature storage medium in the art, such as a Random Access Memory, a flash memory, a Read-Only Memory, a Programmable Read-Only Memory, an Electrically Erasable Programmable Memory, a register, or the like. The storage medium is located in the memory, and the processor reads the information in the memory to complete the operations of the aforementioned methods in combination with its hardware.

It is to be understood that the memory in the embodiments of the disclosure may be a volatile memory or a non-volatile memory, or may include a volatile memory and a non-volatile memory. The non-volatile memory may be a Read-Only Memory (ROM), a Programmable ROM (PROM), an Erasable PROM (EPROM), an Electrically EPROM (EEPROM) or a flash memory. The volatile memory may be a Random Access Memory (RAM), and is used as an external high-speed cache. It is exemplarily but unlimitedly illustrated that RAMs in various forms may be used, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM) or a Direct Rambus RAM (DR RAM). It is to be noted that the memory of the systems and methods described herein is intended to include memories of these and any other proper types, but is not limited thereto.

It is to be understood that the aforementioned memory is exemplarily but unlimitedly illustrated. For example, the memory in the embodiments of the disclosure may further be an SRAM, a DRAM, an SDRAM, a DDR SDRAM, an ESDRAM, an SLDRAM, a DR RAM, or the like. That is, the memory in the embodiments of the disclosure is intended to include memories of these and any other proper types, but is not limited thereto.

An embodiment of the disclosure further provides a storage medium, i.e., a computer-readable storage medium configured to store a computer program.

Optionally, the computer-readable storage medium may be applied to the network device of the embodiments of the disclosure, and the computer program enables a computer to execute corresponding flows implemented by the network device in each method of the embodiments of the disclosure, which is not repeated here for the sake of brevity.

Optionally, the computer-readable storage medium may be applied to the mobile terminal or terminal device of the embodiments of the disclosure, and the computer program enables a computer to execute corresponding flows implemented by the mobile terminal or terminal device in each method of the embodiments of the disclosure, which is not repeated here for the sake of brevity.

An embodiment of the disclosure further provides a computer program product, which includes computer program instructions.

Optionally, the computer program product may be applied to the network device of the embodiments of the disclosure, and the computer program instructions enable a computer to execute corresponding flows implemented by the network device in each method of the embodiments of the disclosure, which is not repeated here for the sake of brevity.

Optionally, the computer program product may be applied to the mobile terminal or terminal device of the embodiments of the disclosure, and the computer program instructions enable a computer to execute corresponding flows implemented by the mobile terminal or terminal device in each method of the embodiments of the disclosure, which is not repeated here for the sake of brevity.

An embodiment of the disclosure further provides a computer program.

Optionally, the computer program may be applied to the network device of the embodiments of the disclosure, and the computer program, when run on a computer, enables the computer to execute corresponding flows implemented by the network device in each method of the embodiments of the disclosure, which is not repeated here for the sake of brevity.

Optionally, the computer program may be applied to the mobile terminal or terminal device of the embodiments of the disclosure, and the computer program, when run on a computer, enables the computer to execute corresponding flows implemented by the mobile terminal or terminal device in each method of the embodiments of the disclosure, which is not repeated here for the sake of brevity.

Those of ordinary skill in the art may realize that the units and algorithm steps of each example described in combination with the embodiments disclosed herein may be implemented by electronic hardware, or a combination of computer software and electronic hardware. Whether these functions are executed in a hardware or software manner depends on specific applications and design constraints of the technical solutions. Professionals may implement the described functions for each specific application by using different methods, but such implementation shall not be regarded as outside the scope of the disclosure.

Those skilled in the art may clearly understand that for convenient and brief description, specific operation processes of the systems, apparatuses and units described above may refer to corresponding processes in the aforementioned method embodiments and will not be repeated here.

In several embodiments provided by the disclosure, it is to be understood that the disclosed systems, apparatuses and methods may be implemented in other manners. For example, the apparatus embodiments described above are only schematic. For example, division of the units is only a kind of logic function division, and other division manners may be adopted during a practical implementation. For example, multiple units or components may be combined or integrated into another system, or some features may be neglected or not executed. In addition, coupling or direct coupling or communication connection between various displayed or discussed components may be indirect coupling or communication connection through some interfaces, apparatuses or units, and may be electrical, mechanical, or in other forms.

Units described as separate components may or may not be physically separated, and components displayed as units may or may not be physical units, that is, may be located in the same place, or may also be distributed to multiple network units. Part or all of the units may be selected according to a practical requirement to implement the purpose of the solutions of the embodiments.

In addition, various function units in various embodiments of the disclosure may be integrated into a processing unit, or each unit may physically exist independently, or two or more than two units may be integrated into a unit.

When implemented in form of a software function unit and sold or used as an independent product, the functions may be stored in a computer-readable storage medium. Based on such understanding, the technical solutions of the disclosure substantially or parts making contributions to the related art or part of the technical solutions may be embodied in form of a software product. The computer software product is stored in a storage medium, including several instructions for enabling a computer device (which may be a personal computer, a server, a network device, or the like) to execute all or part of the operations of the methods in various embodiments of the disclosure. The abovementioned storage medium includes various media capable of storing program codes, such as a USB disk, a mobile hard disk, a ROM, a RAM, a magnetic disk, an optical disk, or the like.

The above are only specific implementations of the disclosure, but the scope of protection of the disclosure is not limited thereto. Any variations or replacements apparent to those skilled in the art within the technical scope disclosed by the disclosure shall fall within the scope of protection of the disclosure. Therefore, the scope of protection of the disclosure shall be subject to the scope of protection of the claims.

1. A wireless communication method, comprising:
receiving, by a terminal device, a first unified Transmission Configuration Indication (TCI) state and/or a second unified TCI state sent from a network device, wherein the first unified TCI state is used for a first uplink channel/signal and/or a first downlink channel/signal, the second unified TCI state is used for a second uplink channel/signal and/or a second downlink channel/signal, the first uplink channel/signal and the second uplink channel/signal have different receiving ends and a same transmitting end, and the first downlink channel/signal and the second downlink channel/signal have different transmitting ends and a same receiving end.

2. The method of claim 1, wherein the first unified TCI state is associated with a first transmission resource or a first transmission resource group to which the first transmission resource belongs, the second unified TCI state is associated with a second transmission resource or a second transmission resource group to which the second transmission resource belongs, the first transmission resource is a transmission resource associated with the first uplink channel/signal or the first downlink channel/signal, and the second transmission resource is a transmission resource associated with the second uplink channel/signal or the second downlink channel/signal.

3. The method of claim 2, wherein the transmission resource comprises at least one of: a Physical Downlink Control Channel (PDCCH) resource, a Control Resource Set (CORESET), a Search Space Set (SSS), a Physical Downlink Shared Channel (PDSCH) resource, a Physical Uplink Shared Channel (PUSCH) resource, a Sounding Reference Signal (SRS) resource, a transmission occasion, a Physical Uplink Control Channel (PUCCH) resource, or a Channel State Information Reference Signal (CSI-RS) resource.

4. The method of claim 2, wherein a configuration manner of a first association relationship between the first unified TCI state and the first transmission resource and a second association relationship between the second unified TCI state and the second transmission resource comprises at least one of:
being configured by the network device; or
being configured by the terminal device,
wherein the first association relationship is configured by first information sent from the network device, the second association relationship is configured by second information sent from the network device, the first information comprises first configuration information for the first transmission resource or the first transmission resource group, the second information comprises second configuration information for the second transmission resource or the second transmission resource group, the first configuration information comprises the first unified TCI state, and the second configuration information comprises the second unified TCI state,
wherein the first information and/or the second information is transmitted through a first signalling, and the first signalling comprises at least one of:
a Radio Resource Control (RRC) signalling;
a Media Access Control Control Element (MAC CE); or
Downlink Control Information (DCI).

5. The method of claim 4, wherein the DCI comprises a first domain for a target transmission resource or a target transmission resource group, the first domain comprises fifth indicative information, and the fifth indicative information is configured to indicate a target unified TCI state associated with the target transmission resource or the target transmission resource group,
wherein the target unified TCI state comprises one of:
the first unified TCI state;
the second unified TCI state;
the first unified TCI state and the second unified TCI state; or
a reserved state.

6. The method of claim 2, wherein if the first downlink channel is a first Physical Downlink Control Channel (PDCCH) and the second downlink channel is a second PDCCH, a first Control Resource Set (CORESET), which is associated with the first PDCCH, is associated with the first unified TCI state, and a second CORESET, which is associated with the second PDCCH, is associated with the second unified TCI state.

7. The method of claim 6, wherein a first channel and/or a first signal scheduled by the first PDCCH is associated with the first unified TCI state, and a second channel and/or a second signal scheduled by the second PDCCH is associated with the second unified TCI state,
wherein
the first channel comprises a first Physical Downlink Shared Channel (PDSCH) and the second channel comprises a second PDSCH; and/or
the first channel comprises a first Physical Uplink Shared Channel (PUSCH) and the second channel comprises a second PUSCH; and/or
the first channel comprises a first Physical Uplink Control Channel (PUCCH) and the second channel comprises a second PUCCH,
wherein
the first signal comprises a first Channel State Information Reference Signal (CSI-RS) and the second signal comprises a second CSI-RS; and/or
the first signal comprises a first Sounding Reference Signal (SRS) and the second signal comprises a second SRS.

8. The method of claim 2, wherein the first uplink channel is a first Physical Uplink Shared Channel (PUSCH) and the second uplink channel is a second PUSCH, a first Sounding Reference Signal (SRS) resource set, which is associated with the first PUSCH, is associated with the first unified TCI state, and a second SRS resource set, which is associated with the second PUSCH, is associated with the second unified TCI state, or
wherein the first uplink channel is a first Physical Uplink Shared Channel (PUSCH) and the second uplink channel is a second PUSCH, a first transmission opportunity, which is associated with the first PUSCH, is associated with the first unified TCI state, and a second transmission opportunity, which is associated with the second PUSCH, is associated with the second unified TCI state.

9. The method of claim 1, wherein the first unified TCI state comprises a first joint TCI state, the second unified TCI state comprises a second joint TCI state, the first joint TCI state is used for the first downlink channel/signal and the first uplink channel/signal, and the second joint TCI state is used for the second uplink channel/signal and the second downlink channel/signal, or wherein the first united TCI state comprises a first separate uplink TCI state and a first separate downlink TCI state, the second united TCI state comprises a second separate uplink TCI state and a second separate downlink TCI state, the first separate downlink TCI state is used for the first downlink channel/signal, the first separate uplink TCI state is used for the first uplink channel/signal, the second separate downlink TCI state is used for the second downlink channel/signal, and the second separate uplink TCI state is used for the second uplink channel/signal.

10. A wireless communication method, comprising:
sending, by a network device, a first unified Transmission Configuration Indication (TCI) state and/or a second unified TCI state to a terminal device, wherein the first unified TCI state is used for a first uplink channel/signal and/or a first downlink channel/signal, the second unified TCI state is used for a second uplink channel/signal and/or a second downlink channel/signal, the first uplink channel/signal and the second uplink channel/signal have different receiving ends and a same transmitting end, and the first downlink channel/signal and the second downlink channel/signal have different transmitting ends and a same receiving end.

11. The method of claim 10, wherein the first unified TCI state is associated with a first transmission resource or a first transmission resource group to which the first transmission resource belongs, the second unified TCI state is associated with a second transmission resource or a second transmission resource group to which the second transmission resource belongs, the first transmission resource is a transmission resource associated with the first uplink channel/signal or the first downlink channel/signal, and the second transmission resource is a transmission resource associated with the second uplink channel/signal or the second downlink channel/signal,
wherein the transmission resource comprises at least one of: a Physical Downlink Control Channel (PDCCH) resource, a Control Resource Set (CORESET), a Search Space Set (SSS), a Physical Downlink Shared Channel (PDSCH) resource, a Physical Uplink Shared Channel (PUSCH) resource, a Sounding Reference Signal (SRS) resource, a transmission occasion, a Physical Uplink Control Channel (PUCCH) resource, or a Channel State Information Reference Signal (CSI-RS) resource,
wherein a determination manner of a first association relationship between the first unified TCI state and the first transmission resource and a second association relationship between the second unified TCI state and the second transmission resource comprises at least one of:
being configured by the network device; or
being configured by the terminal device.

12. The method of claim 11, wherein the first association relationship is configured by first information sent from the network device, the second association relationship is configured by second information sent from the network device, the first information comprises first configuration information for the first transmission resource or the first transmission resource group, the second information comprises second configuration information for the second transmission resource or the second transmission resource group, the first configuration information comprises the first unified TCI state, and the second configuration information comprises the second unified TCI state,
wherein the first information and/or the second information are/is transmitted through a first signalling, and the first signalling comprises at least one of:
a Radio Resource Control (RRC) signalling;
a Media Access Control Control Element (MAC CE); or
Downlink Control Information (DCI).

13. The method of claim 12, wherein the DCI comprises a first domain for a target transmission resource or a target transmission resource group, the first domain comprises fifth indicative information, and the fifth indicative information is configured to indicate a target unified TCI state associated with the target transmission resource or the target transmission resource group,
wherein the target unified TCI state comprises one of:
the first unified TCI state;
the second unified TCI state;
the first unified TCI state and the second unified TCI state; or
a reserved state,
wherein if the first downlink channel is a first Physical Downlink Control Channel (PDCCH) and the second downlink channel is a second PDCCH, a first Control Resource Set (CORESET), which is associated with the first PDCCH, is associated with the first unified TCI state, and a second CORESET, which is associated with the second PDCCH, is associated with the second unified TCI state.

14. The method of claim 13, wherein a first channel and/or a first signal scheduled by the first PDCCH is associated with the first unified TCI state, and a second channel and/or a second signal scheduled by the second PDCCH is associated with the second unified TCI state,
wherein
the first channel comprises a first Physical Downlink Shared Channel (PDSCH) and the second channel comprises a second PDSCH; and/or
the first channel comprises a first Physical Uplink Shared Channel (PUSCH) and the second channel comprises a second PUSCH; and/or
the first channel comprises a first Physical Uplink Control Channel (PUCCH) and the second channel comprises a second PUCCH,
wherein
the first signal comprises a first Channel State Information Reference Signal (CSI-RS) and the second signal comprises a second CSI-RS; and/or
the first signal comprises a first Sounding Reference Signal (SRS) and the second signal comprises a second SRS.

15. The method of claim 11, wherein the first uplink channel is a first Physical Uplink Shared Channel (PUSCH) and the second uplink channel is a second PUSCH, a first Sounding Reference Signal (SRS) resource set, which is associated with the first PUSCH, is associated with the first unified TCI state, and a second SRS resource set, which is associated with the second PUSCH, is associated with the second unified TCI state, or
wherein the first uplink channel is a first Physical Uplink Shared Channel (PUSCH) and the second uplink channel is a second PUSCH, a first transmission opportunity, which is associated with the first PUSCH, is associated with the first unified TCI state, and a second transmission opportunity, which is associated with the second PUSCH, is associated with the second unified TCI state, or
wherein the first unified TCI state comprises a first joint TCI state, the second unified TCI state comprises a second joint TCI state, the first joint TCI state is used for the first downlink channel/signal and the first uplink channel/signal, and the second joint TCI state is used for the second uplink channel/signal and the second downlink channel/signal, or
wherein the first united TCI state comprises a first separate uplink TCI state and a first separate downlink TCI state, the second united TCI state comprises a second separate uplink TCI state and a second separate downlink TCI state, the first separate downlink TCI state is used for the first downlink channel/signal, the first separate uplink TCI state is used for the first uplink channel/signal, the second separate downlink TCI state is used for the second downlink channel/signal, and the second separate uplink TCI state is used for the second uplink channel/signal.

16. A communication device, comprising:
a processor, a memory and a transceiver, wherein the memory is configured to store a computer program, and the processor is configured to call and run the computer program stored in the memory to control the transceiver to perform an operation of:
receiving a first unified Transmission Configuration Indication (TCI) state and/or a second unified TCI state sent from a network device, wherein the first unified TCI state is used for a first uplink channel/signal and/or a first downlink channel/signal, the second unified TCI state is used for a second uplink channel/signal and/or a second downlink channel/signal, the first uplink channel/signal and the second uplink channel/signal have different receiving ends and a same transmitting end, and the first downlink channel/signal and the second downlink channel/signal have different transmitting ends and a same receiving end.

17. The communication device of claim 16, wherein the first unified TCI state is associated with a first transmission resource or a first transmission resource group to which the first transmission resource belongs, the second unified TCI state is associated with a second transmission resource or a second transmission resource group to which the second transmission resource belongs, the first transmission resource is a transmission resource associated with the first uplink channel/signal or the first downlink channel/signal, and the second transmission resource is a transmission resource associated with the second uplink channel/signal or the second downlink channel/signal.

18. The communication device of claim 17, wherein the transmission resource comprises at least one of: a Physical Downlink Control Channel (PDCCH) resource, a Control Resource Set (CORESET), a Search Space Set (SSS), a Physical Downlink Shared Channel (PDSCH) resource, a Physical Uplink Shared Channel (PUSCH) resource, a Sounding Reference Signal (SRS) resource, a transmission occasion, a Physical Uplink Control Channel (PUCCH) resource, or a Channel State Information Reference Signal (CSI-RS) resource.

19. The communication device of claim 17, wherein a configuration manner of a first association relationship between the first unified TCI state and the first transmission resource and a second association relationship between the second unified TCI state and the second transmission resource comprises at least one of:
being configured by the network device; or
being configured by the terminal device,
wherein the first association relationship is configured by first information sent from the network device, the second association relationship is configured by second information sent from the network device, the first information comprises first configuration information for the first transmission resource or the first transmission resource group, the second information comprises second configuration information for the second transmission resource or the second transmission resource group, the first configuration information comprises the first unified TCI state, and the second configuration information comprises the second unified TCI state,
wherein the first information and/or the second information is transmitted through a first signalling, and the first signalling comprises at least one of:
a Radio Resource Control (RRC) signalling;
a Media Access Control Control Element (MAC CE); or
Downlink Control Information (DCI).

20. The communication device of claim 19, wherein the DCI comprises a first domain for a target transmission resource or a target transmission resource group, the first domain comprises fifth indicative information, and the fifth indicative information is configured to indicate a target unified TCI state associated with the target transmission resource or the target transmission resource group,
wherein the target unified TCI state comprises one of:
the first unified TCI state;
the second unified TCI state;
the first unified TCI state and the second unified TCI state; or
a reserved state.
